(19) United States
(12) Patent Application Publication
(10) Pub. No.: US 2007/0251824 A1
(43) Pub. Date: Nov. 1, 2007

(54) Multiplexed analyte quantitation by two-dimensional planar electrochromatography

(75) Inventors: Wayne F. Patton, Newton, MA (US); Linan Song, Woburn, MA (US); Nancy C. Wilker, Lexington, MA (US)

Correspondence Address: WILMER, HALE, PERKIN & ELMER, LLP, 60 STATE STREET, BOSTON, MA, 02109, US

(73) Assignee: PerkinElmer LAS, Inc., Waltham, MA (US)

(21) Appl. No.: 11/657,922

(22) Filed: Jan. 24, 2007

Related U.S. Application Data
(60) Provisional application No. 60/761,584, filed on Jan. 24, 2006.

(51) Int. Cl. B01D 57/02

(52) U.S. Cl. 204/461

(57) ABSTRACT

The invention relates to methods for isolating an analyte of interest in a sample suspected of containing the analyte of interest using two-dimensional planar electrochromatography. The methods comprise treating at least a portion of the sample with a mobility modifier capable of modifying the mobility of the analyte of interest after the second dimension of planar electrochromatography. Kits and compositions are also disclosed.

### CROSS-REFERENCE TO RELATED APPLICATION

This application claims the benefit under 35 U.S.C. §119(e) of U.S. Provisional Patent Application No. 60/761,584, filed on Jan. 24, 2006, entitled Multiplexed Peptide Quantification by Two-Dimensional Diagonal Planar Electrochromatography, which is incorporated herein by reference in its entirety.

### FIELD OF INVENTION

The invention relates to biochemistry and proteomics. More specifically, the invention relates to the separation and detection of multiple analytes.

### BACKGROUND

Large sets of biological samples are commonly encountered in modern biomedical research and rigorous and reliable methods for quantitating proteins obtained from them are required. Currently, the progress in the field of proteomics is limited by the inability to conduct simultaneous quantitative analysis of multiple samples. Multiple samples are usually run serially, and not in a single experimental assay. Many proteomics-based experiments are overly simplistic in their basic assumption that all of the information required in an experiment can be obtained using a single sample or an easy control-versus-perturbed state experimental design. The analysis of drug dose-response curves or the kinetics of changes in tissue/cell proteomes require multiplexed quantitation. Evaluation of different stages of cancer progression and epidemiological studies of global protein expression also require highly multiplexed analysis of samples. The inability to analyze multiple samples simultaneously significantly impacts data quality and throughput speed, as each sample is subjected to individual process variables during preparation. Consequently, high statistical variation or poor precision in the quantitative measurements render experimental results difficult or impossible to interpret.

The human proteome is known to contain approximately 30,000 different genes. But, due to post-translational modifications and differential mRNA splicing, the total number of distinct proteins is most likely to be close to one million. The level of complexity, coupled with the relative abundances of different proteins, presents unique challenges in terms of separations technologies. Analytical methods for the simultaneous quantitative analysis of the abundances, locations, modifications, temporal changes and interactions of thousands of proteins are important to proteomics. Two-dimensional or even multi-dimensional protein separations, based upon different physicochemical properties of the constituent proteins, are favored over single dimension separations in proteomics due to the increased resolution afforded by the additional dimensions of fractionation. Two-dimensional separation systems can be categorized by the type of interface between the dimensions. In “heart-cutting” methods a region of interest is selected from the first dimension and the selected region is subjected to second dimension separation. Systems that subject the entire first dimension to a second dimension separation, or alternatively sample the effluent from the first dimension at regular intervals and fixed volumes for subsequent fractionation in the second dimension, are referred to as “comprehensive” methods.

The principal protein separation technology used today is high-resolution two-dimensional gel electrophoresis (2DGE). High resolution 2DGE involves the separation of proteins in the first dimension according to their charge by isoelectric focusing and in the second dimension according to their relative mobility by sodium dodecyl sulfate polyacrylamide gel electrophoresis. The technique is capable of simultaneously resolving thousands of polypeptides as a constellation pattern of spots, and is used for the global analysis of metabolic processes such as protein synthesis, glycolysis, gluconeogenesis, nucleotide biosynthesis, amino acid biosynthesis, lipid metabolism and stress response. It is also used for the analysis of signal transduction pathways, to detect global changes in signaling events, as well as to differentiate between changes in protein expression and degradation from changes arising through post-translational modification.

Polyacrylamide gels are mechanically fragile, susceptible to stretching and breaking during handling. Analysis using 2DGE produces a random pattern of smudged, watery ink spots on a wobbly, sagging, gelatinous-like slab. Other limitations include difficulty in automating the separation process, low throughput of samples, and difficulty in detecting low abundance, extremely basic, very hydrophobic, very high molecular weight or very low molecular weight proteins. While detection of proteins directly in gels with labeled antibodies or lectins has been accomplished, the approach is not generally applicable to every antigen and is relatively insensitive. Consequently, proteins are usually electrophoretically transferred to polymeric membranes before specific targets are identified. The polyacrylamide gel also poses difficulties in the identification of proteins by microchemical characterization techniques, such as mass spectrometry, since the gels must be macerated and rinsed, the proteins must be incubated with proteolytic enzymes, and peptides must be selectively retrieved and concentrated using a reverse-phase column prior to identification.

Integral membrane proteins play an important role in signal transduction and are thus primary drug targets pursued by the pharmaceutical industry. The proteins typically contain one or more hydrophobic, transmembrane domains that intermingle with the hydrophobic portion of lipid bilayer membranes. The 2DGE technique is poorly suited for the fractionation of hydrophobic proteins, particularly proteins containing two or more alpha-helical transmembrane domains, because the technique is based upon aqueous buffers and hydrophilic polymers.

Two-dimensional liquid chromatography-tandem mass spectrometry (2D LC/MS/MS) has been used as an alternative analytical approach for protein separation. In 2D LC/MS/MS, a proteolytic digest of a complex protein sample is loaded onto a microcapillary column that is packed with two independent chromatography phases, a strong cation exchanger and a reverse-phase material. Peptides are iteratively eluted directly into a tandem mass spectrometer and the spectra generated are correlated to theoretical mass spectra obtained from protein or DNA databases. This peptide-based approach to proteomics generates large number of peptides from a specimen that exceeds the analytical capacity of the LC-MS system. Consequently, strategies have been developed that retrieve a small percentage (3-5%) of the peptides from a complex digest, such as tryptic peptides containing only cysteine residues or only histidine residues. The remaining 95-98% of the peptides are discarded, thus prohibiting a comprehensive analysis of the sample. Additionally, such procedures are unable to distinguish among the various protein isoforms exhibited in a proteome that arise from differential mRNA splicing and post-translational modification due to a combination of poor sequence coverage and the sequence scrambling arising from the fragmentation process itself.

Another technique applied to the analysis of peptides and proteins is capillary electrochromatography (CEC), but its use has been limited to 1-D capillary separations of model analytes. CEC is a hybrid separation technique that couples capillary zone electrophoresis (CZE) with high-performance liquid chromatography (HPLC). In CEC, both chromatographic and electrophoretic processes determine the magnitude of the overall migration rates of the analytes. Unlike HPLC, where the dominant force is hydraulic flow, the driving force in CEC is electroosmotic flow. When a high voltage is applied, positive ions accumulate in the electric double layer of the particles in the column packing and move towards the cathode, dragging the liquid phase with them. The separation mechanism in CEC is based upon both kinetic processes (electrokinetic migration) and thermodynamic processes (partitioning). This combination reduces band broadening and thus allows for higher separation efficiencies.

Electroosmotic flow depends upon the surface charge density, the field strength, and the thickness of the electric double layer and the viscosity of the separation medium, which in turn depends upon the temperature. Electroosmotic flow is highly dependent upon pH, buffer concentration (ionic strength), the organic modifier and the type of stationary phase employed. CEC separations can be performed isocratically, thus dispensing with the requirement for gradient elution, which in turn simplifies instrumentation requirements.

Other techniques for protein separations include the use of planar electrophoresis and membrane electrophoresis, such as electrically-driven cellulose filter paper-based separation of proteins, where hydrophilic cellulose-based filter paper is utilized as the stationary phase and dilute aqueous phosphate buffer as the electrode buffer. Using this technique, plasma proteins could be separated in the first dimension by electrophoresis and in the second dimension by paper chromatography. The cellulose polymer is too hydrophilic to provide for significant binding of proteins to the solid-phase surface. Thus, the proteins interact minimally with filter paper in aqueous medium, and once the applied current is removed the separation pattern will degrade rapidly due to diffusion. In the case of cellulose acetate membranes, electroosmosis is often minimized through derivatization of the acetate moieties with agents such as boron trifluoride and separations are subsequently achieved by conventional isoelectric focusing. The cellulose acetate membranes are considered extremely fragile for diagnostic applications in clinical settings and the generated profiles of very hydrophilic proteins, such as urinary and serum proteins, are poor compared to those generated with polyacrylamide gels.

Another electrically-driven polymeric membrane-based separation process includes electromolecular propulsion (EMP) which involves the use of complex nonaqueous mobile phase buffers composed of four or more different organic solvents that are free of electrically conductive trace contaminants.

One limitation of currently implemented multiplexing approaches, is their reliance upon fairly sophisticated tandem mass spectrometry instruments. Higher levels of multiplexing may even require more complex triple stage mass spectrometry instruments. There is a need in the art for robust multiplexing approaches that are based upon simpler mass spectrometry techniques, or that require no mass spectrometry instrument at all.

### SUMMARY OF THE INVENTION

In one aspect, the invention provides a method for isolating an analyte of interest in a sample suspected of containing the analyte of interest by two-dimensional planar electrochromatography comprising: a) subjecting the sample to planar electrochromatography in a first dimension; b) modifying the mobility of the analyte of interest; and c) subjecting the sample to non-orthogonal planar electrochromatography in a second dimension; wherein the mobility-modified analyte of interest migrates differently and distinguishably from the other analytes in the sample.

In another aspect, the invention provides a method for isolating an analyte of interest in a sample suspected of containing the analyte of interest by two-dimensional planar electrochromatography comprising: a) subjecting the sample to planar electrochromatography in a first dimension; b) treating at least a portion of the sample after it has been subjected to electrochromatography in the first dimension with a mobility modifier capable of modifying the mobility of the analyte of interest; and c) subjecting the sample treated with the mobility modifier to non-orthogonal planar electrochromatography in a second dimension; wherein the mobility-modified analyte of interest migrates differently and distinguishably from the other analytes in the sample.

The sample can be selected from a biological source, an environmental source or an industrial source. In some embodiments, the analyte of interest is a protein, a peptide, a carbohydrate, a fatty acid, a chemical, a nucleic acid molecule, a lipid, DNA, RNA, DNA-RNA hybrid or a peptide nucleic acid.

The mobility modifier can be a protease, an endonuclease, an exonuclease, a kinase, a phosphatase, a lipidase, a glycosidase, a nucleic acid binding protein, a nucleic acid and a phosphomonoester-selective binding agent, an antibody, an ion chelating solution, a solution comprising Zn⁺⁺ ions, or a solution comprising Mn⁺⁺ ions. In one embodiment, the mobility modifier is a nucleic acid binding agent, such as a ribozyme, a deoxyribozyme, a methylase, a ligase or a terminase.

In some embodiments, the method further comprises analyzing the sample prior to subjecting it to planar electrochromatography using a gel electrophoresis, high performance liquid chromatography or fast protein liquid chromatography.

The sample can be pretreated prior to subjecting it to planar electrochromatography. In some embodiments, the sample is pretreated by contacting the sample with an antibody, a phosphomonoester-selective binding agent, a nucleic acid binding protein, or a mass tag. The contacting can create a covalent or non-covalent bond between the reagent and the analyte of interest. In one embodiment, the sample is pretreated by digestion with a protease, for example trypsin.

In one embodiment, the reagent is coupled to a matrix, wherein the sample is loaded onto the matrix prior subjecting the sample to planar chromatography in the first dimension.

The methods can further comprise quantitating the mobility modifier-treated analyte of interest subjected to planar electrochromatography in the second dimension.

The mobility modifier can be coupled to a detectable label. The detectable label can be a fluorescent label, a radioactive label, a luminescent label or a colorimetric label. The quantitating step can comprise quantitating the amount of the detectable label.

The mobility modifier can be a light source, a heat source, a cooling source, an acidic solution or vapor, a basic solution or vapor, a solution comprising Zn⁺⁺ ions, a solution comprising Mn⁺⁺ ions, and an ion chelating solution. In some embodiments, a buffer (or a mobile phase) having a different temperature that the mobile phase used in the planar electrochromatography in the first dimension is a heat source or a cooling source.

In one embodiment, the method further comprises coupling the analyte of interest to a first member of an affinity pair prior to subjecting it to planar electrochromatography in the first dimension. The mobility modifier can be a second member of the affinity pair, which can, optionally, be coupled to a detectable label.

In yet another aspect, the invention provides a method for multiplex analysis of a protein of interest in a sample from multiple sources suspected of containing the protein of interest by two-dimensional planar electrochromatography comprising: a) treating a plurality of sources suspected of containing the protein of interest with a set of mass tags to covalently couple the mass tags to the protein of interest, wherein each source is treated with a different mass tag from the set; b) combining the plurality of sources suspected of containing the protein of interest treated with the set of mass tags to produce a sample; c) subjecting the sample to planar electrochromatography in a first dimension; d) treating at least a portion of the sample after it has been subjected to electrochromatography in the first dimension with a mobility modifier, wherein the mobility modifier fragments the mass tags into non-isobaric fragments; e) subjecting the sample treated with the mobility modifier to non-orthogonal planar electrochromatography in a second dimension; and f) comparing fragments of the mass tags to identify the source of the protein of interest.

In some embodiments, the mass tags in the set are isobaric. The mass tags and the isobaric mass tags can be polypeptides. In some embodiments, each isobaric or non-isobaric mass tag comprises a labile bond selected from the group consisting of an aspartic acid-proline bond and an asparagine-proline bond.

In one embodiment, each isobaric or non-isobaric mass tag has the labile bond at a different position from any other isobaric mass tag of the set.

In another embodiment, each isobaric or non-isobaric mass tag has the labile bond at the same position as every other isobaric mass tag of the set.

In some embodiments, the method further comprises quantitating the non-isobaric fragments of the isobaric mass tags, for example using mass spectrometry.

In one aspect, the invention provides a kit for isolating an analyte of interest in a sample suspected of containing the analyte of interest by two-dimensional planar electrochromatography comprising: a) a matrix for use in two-dimensional planar electrochromatography; b) a mobility modifier; and c) a set of instructions for use.

In some embodiments, the mobility modifier is an antibody, a phosphomonoester-selective binding agent, a protease, a nucleic acid molecule, a nucleic acid binding protein, a peptide, a protein and a member of an affinity pair, kinase, a phosphatase, a lipidase, or a glycosidase. Optionally, the mobility modifier can be coupled to a detectable label.

In some embodiments, the matrix for use in two-dimensional planar electrochromatography comprises a material selected from the group consisting of a non-porous particle bed, a polymeric monolith, and silica.

In another aspect, the invention provides a kit for multiplex analysis of an analyte of interest in a sample from multiple sources suspected of containing the analyte of interest by two-dimensional planar electrochromatography comprising: a) a matrix for use in two-dimensional planar electrochromatography; b) a mobility modifier; c) a set of isobaric mass tags; and d) a set of instructions for use.

In yet another aspect, the invention provides a kit for multiplex analysis of an analyte of interest in a sample by two-dimensional planar electrochromatography comprising: a) a matrix for use in two-dimensional planar electrochromatography; b) a mobility modifier; c) a reagent that selectively binds to the analyte; d) a set of instructions for use.

In some embodiments, the reagent is an antibody, a nucleic acid molecule, a phosphomonoester-selective binding agent, a nucleic acid binding protein, a peptide, a protein or a member of an affinity pair. The mobility modifier can be a light source, a heat source, an acidic solution and a basic solution.

In one embodiment, the kit further comprises a set of mass tags.

In one aspect, the invention provides a kit for multiplex analysis of an analyte of interest in a sample from multiple sources suspected of containing the analyte of interest by two-dimensional planar electrochromatography comprising: a) a matrix for use in two-dimensional planar electrochromatography, wherein a reagent that selectively binds to the analyte is located with the matrix; b) a mobility modifier, wherein the mobility modifier disrupts the binding of the analyte to the reagent; and c) a set of instructions for use.

In one aspect, the invention provides a composition comprising: a) a matrix for use in two-dimensional planar electrochromatography; and b) a mobility modifier.

The invention is based, in part, on the surprising discovery in multiplex detection of analytes, expensive tandem mass spectrometry (MS/MS) can be avoided by using planar two-dimensional electrochromatography and a mobility modifier.

### BRIEF DESCRIPTION OF DRAWINGS

In the drawings:

FIG. 1 is a schematic diagram of a first portion of a multiplex assay according to one embodiment of the invention;

FIG. 2 is a schematic diagram of a second portion of a multiplex assay according to one embodiment of the invention;

FIG. 3 illustrates physiological phenomena associated with bradykinin-induced changes in endothelial cells;

FIG. 4 illustrates a representative kinetic inflammatory response of endothelial monolayers with respect to intracellular calcium levels;

FIG. 5 is a schematic diagram of a first portion of a multiplex assay according to one embodiment of the invention;

FIG. 6 is an image of a two-dimensional gel used in connection with the assay according to one embodiment of the invention;

FIG. 7 is a schematic diagram of a second portion of an assay according to one embodiment of the invention;

FIG. 8 is an image of a one-dimensional planar electrochromatography experiment with a mixture of phosphorylated and unphosphorylated peptides;

FIG. 9 shows the images of a non-orthogonal two-dimensional planar electrochromatography experiments of a phosphorylated peptide and an unphosphorylated peptide without treatment with a Phos-tag™ molecule (plate A), and with treatment with a Phos-tag™ molecule (plate B); and

FIG. 10 shows images of a non-orthogonal two-dimensional planar electrochromatography experiment of a mixture of phosphorylated and unphosphorylated peptides without treatment with a Phos-tag™ molecule (plate A), and with treatment with a Phos-tag™ molecule (plate B).

### DETAILED DESCRIPTION OF THE INVENTION

### Definitions

As used herein, “planar electrochromatography” (PEC) refers to an analyte separation system that employs a solid phase support and mobile phases to facilitate the fractionation of analytes primarily by the flow of a fluid between two electrodes to provide an electroosmotic driving force, and secondarily by a combination of electrophoretic and/or chromatographic mechanisms. The mobile phase can be an aqueous phase, an organic phase or combinations thereof. Different embodiments of planar electrochromatography have been described in Pub No. US 2005-0269267, U.S. Ser. No. 11/595,234, filed Nov. 10, 2006 and U.S. Ser. No. 11/636,327, filed Dec. 8, 2006, Patton et al. (2006), Journal of Liquid Chromatography & Related Technologies 29:1177-1218, all of which are incorporated by reference herein in their entireties.

In PEC, both chromatographic and electrophoretic processes determine the magnitude of the overall migration rates of the analytes. The driving force of PEC is electroosmotic flow (EOF), rather than hydraulic flow (the dominant force in Liquid Chromatography (LC)) or the electrophoretic mobility prevalent in simple Flatbed electrophoresis (FBE). The PEC technique is unusual in that the separation mechanism is based upon both kinetic processes (electrokinetic migration) and thermodynamic processes (partitioning). This combination reduces band broadening and allows for higher separation efficiencies compared with LC.

Electroosmotic flow depends upon such factors as the surface charge density, the field strength, the thickness of the electric double layer, and the viscosity of the separation medium, which in turn depends upon the temperature. In practical terms, electroosmotic flow is dependent upon pH, buffer concentration (ionic strength), the organic modifier, and the type of stationary phase employed.

As used herein, an “amphiphilic stationary phase” refers to a solid-support stationary phase exhibiting both non-polar and polar interactions with an analyte. An amphiphilic stationary phase includes regions, phases or domains that are nonionic and/or hydrophobic in nature as well as regions, phases or domains that are highly polar and preferably ionic. The ionic regions can be positively or negatively charged. Hydrophobic groups favor the interaction and retention of a non-polar analyte during separation, while the ionic groups promote the formation of the charged double layer used in electrokinetic separation. In one embodiment, the amphiphilic stationary phase for analyte fractionation has a combination of charge carrying groups (ion exchangers), non-covalent groups, and nonionic groups that facilitate chemical interactions with the analytes. In another embodiment, the amphiphilic stationary phase is predominantly hydrophobic, but partially ionic in character.

As used herein, “non-orthogonal” refers to a two-dimensional planar electrochromatography experiment wherein the experiment run the first dimension and the experiment run in a second dimension are statistically dependent. In some embodiments, “non-orthogonal” refers to a two-dimensional planar electrochromatography experiment where the analytes migrate to a diagonal of a two-dimensional PEC experiment in the absence of treatment with a mobility modifier. In other embodiments, “non-orthogonal” refers to a two-dimensional planar separation experiment where the relative extent or order of migration of the analytes (in the absence of the mobility modifier) is the same in the first and second dimension.

As used herein, a “matrix” refers to a stationary phase for use in two-dimensional planar electrochromatography. Examples of such matrices include, but are not limited to, a non-porous particle bed (analytes separate in the binder between the particles), a polymeric monolith, a porous particulate bed such as silica, as well as other stationary phases described herein.

As used herein, a “mobility modifier” refers to any agent or condition that modifies the relative mobility of an analyte of interest in the second dimension of planar electrochromatography compared to the mobility of the analyte of interest in the first dimension of planar electrochromatography. Examples of a mobility modifier include, but are not limited to, light, heat, an acidic solution or vapor, a basic solution or vapor, a solution containing a divalent ion (such as Zn²⁺ or Mn²⁺), an antibody, a phosphomonoester-selective binding agent, a protease, a glycosidase, a lipase, a protein, a peptide, a nucleic acid, a nucleic acid binding protein, a nuclease, a kinase, and a member of an affinity pair.

As used herein, an “affinity pair” refers to a pair of molecules that exhibit strong non-covalent interaction. Affinity pairs include, but are not limited to, biotin-avidin, biotin-streptavidin, heavy metal derivative-thio group, various homopolynucleotides such as poly dG-poly dC, polydA-poly dT and poly dA-poly dU, various oligonucleotides of specific sequences (where the analyte of interest comprises a nucleic acid sequence that hybridizes to the oligonucleotide), and antigen (or epitopes thereof)-antibody pairs.

As used herein, a “biological source” refers to a source suspected of containing an analyte of interest that is of biological origin, for example, obtained from a plant, an animal, or a human.

As used herein, a “environmental source” refers to a source suspected of containing an analyte of interest that is of environmental origin, for example, obtained from soil, rock, lake, river, ocean or air.

As used herein, an “industrial source” refers to a source suspected of containing an analyte of interest, that is of industrial origin, for example, obtained from sewage, waste, exhaust or a pollution source.

As used herein, a “chemical” refers to an organic or inorganic molecule, which is capable of being mobility-altered. Examples of chemicals include, but are not limited to, drugs, drug metabolites, poisons and pollutants.

As used herein, by “couple” or “coupling” is meant a covalent or non-covalent (e.g., ionic or hydrogen) chemical bond.

As used herein, “isobaric” means having the same total mass. In some embodiments, isobaric tags become non-isobaric after being treated with a mobility modifier.

By “selective binding” or “selectively bind” is meant that binding agent (or reagent) non-covalently binds to target (e.g., a phosphomonoester residue, an analyte, or an epitope on the analyte) with a dissociation constant (K_{d}) of about 500 nM, or about 100 nM, or about 50 nM, or about 25 nM, or about 2.5 nM.

As used herein, “phosphomonoester-selective binding agent” is meant a reagent that selectively binds to phosphate monoester (i.e., a phosphomonoester) residues.

In some embodiments, the phosphomonoester-selective binding agent of the present invention is described in Koike et al., U.S. Patent Publication No. 2005-0038258 published Feb. 17, 2005, Koike et al., U.S. Patent Publication No. 2004-0198712 published Oct. 7, 2004; Koike et al., European Patent Publication No. 1614706 published Jan. 11, 2006; Pub. No. US 2006/0183237, Pub. No. US 2006/0131239, WO 2004/079358, JP 2004-172901, PCT/JP2005/018323, PCT/JP2004/015347, U.S. Ser. No. 10/575,714, PCT/JP2005/014469, PCT/JP2006/315705, Kinoshita et al. (2006) Molecular & Cellular Proteomics 5: 749-757 and Kinoshita et al., (2004) Dalton Trans., 1189-1193; Koike et al., European Patent Publication No. 1602923 published Dec. 7, 2005; Yashiro et al. (1995) J. Chem. Soc. Commun. 17: 1793-1794; and Yamaguchi et al. (2001) Chem. Commun. 4: 375-376; and Kinoshita et al. (2005) J. Sep. Sci. 28: 155-162, all of which are incorporated herein by reference in their entireties.

In one or more embodiments, the “phosphomonoester-selective binding agent” of the invention excludes antibodies, such as monoclonal antibodies, polyclonal antibodies, and antibody fragments. In one or more embodiments, the phosphomonoester-selective binding agent of the invention is a Phos-tag™ molecule and comprises the following structure:

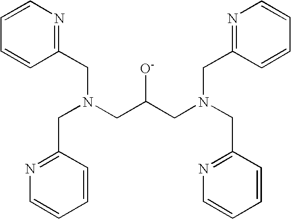

When the pyridyl groups of the above-structure are bound to a divalent cation, the above structure will specifically bind to a phosphomonoester residue. In some embodiments, the divalent cation is Zn⁺⁺. In other embodiments, the divalent cation is Mn⁺⁺. In some embodiments, the dissociation constant (K_{d}) of the binding of the above-structure to a phosphate monoester residue is about 25 nM.

Methods, kits and compositions disclosed herein allow the analysis of many analytes simultaneously with high internal accuracy in comparison to a sequential analysis system. Thus, they can be used as a detection system in a number of fields, including, but not limited to, proteomics, expression profiling, comparative genomics, immunology, diagnostic assays, drug efficacy and toxicity assays and quality control. The disclosed methods, kits and compositions may be understood more readily by reference to the following detailed description of particular embodiments and the Examples included therein and to the Figures.

An exemplary assay for the selective isolation and/or detection of one or multiple analytes of interest by non-orthogonal two-dimensional planar electrochromatography (2DPEC) is described. The analytes from one or more sources are combined into a single sample and subjected to planar electrochromatography separation in a first dimension to separate an analyte or groups of analytes according to different mobilities under the conditions of a first dimension of two-dimensional planar elctrochromatography. The mobility of the analytes of interest is subsequently selectively altered, for example, by treatment with a mobility modifier, while the analytes are still inside the planar electrochromatography matrix, resulting in modification of the mobility of the analytes of interest. The mobility of the remaining analytes remains substantially unchanged. All analytes or a portion of the analytes including the mobility-modified analytes of interest are then subjected to planar electrochromatography in the second dimension, where they are distinguished from other analytes. Since the first and second PEC separations are conducted under non-orthogonal conditions, it is expected that the relative mobilities of the analytes remain substantially unchanged and the order of elution or separation of the analytes remains substantially similar. However, due to the change in the mobility of the analytes treated with the mobility modifier, the relative mobilities and/or order of elution of analytes is changed and the mobility-modified analytes of interest can be readily detected. The analytes of interest can subsequently be quantitated using a conventional single-stage mass spectrometer, such as a matrix-assisted laser desorption/ionization orthogonal time-of-flight mass spectrometer (MALDI-oTOF MS) or even by using an analytical gel imaging device after, for example, post-separation labeling with a fluorescent reagent, such as fluorescamine. In some embodiments, post-separation labeling is performed directly on the PEC plate.

### Mobility Modifiers

After subjecting a sample to a planar electrochromatography in a first dimension, a mobility modifier is used to selectively modify the mobility of an analyte of interest, while leaving the mobility of other analytes unchanged. Thus, the analytes of interest, whose mobility has been modified by the mobility modifier, will migrate differently in the second dimension of planar electrochromatography compared to the analytes whose mobility has remained unmodified. As a result, the analytes of interest will be separated from other analytes by planar electrochromatography in the second dimension, including from the analytes that co-migrated with them in the first dimension. In some instances, treatment of the analyte of interest with a mobility modifier prevents it from migrating in the second dimension of PEC, which is also considered to be a mobility modification.

A mobility modifier can increase or decrease the mobility of the analyte of interest. The mobility modifier interacts selectively with the analyte(s) of interest so that the mobility of the analyte(s) of interest are selectively modified. The mobility of the remaining analytes are substantially unchanged. For example, the mobility modifier can decrease the mobility of the analyte of interest by altering the charge, mass, or interaction with the planar electrochromatography matrix of the analyte of interest. If a mass tag is covalently coupled to the analyte of interest, a mobility modifier can interact with the mass tag, altering the mobility of the mass tag and, therefore, altering the mobility of the analyte to which the mass tag is coupled.

In some embodiments, the mobility modifier can decrease the mobility of the analyte of interest by increasing its mass. Mass of the analyte of interest can be increased, for example, by selectively binding the mobility modifier to the analyte of interest. If the analyte of interest is a specific protein, the mobility modifier can be an antibody or another protein that specifically binds to the protein of interest (or to a portion or fragment thereof), but not to other proteins. If the protein of interest is phosphorylated, the mobility modifier may be an antibody or a molecule that will specifically alter the mobility of the phosphorylated protein. Commercially available antibodies that can recognize phosphorylated amino acids include, but are not limited to, anti-phosphothreonine antibodies (e.g., from Sigma-Aldrich Chemical Co., St. Louis, Mo., catalog no. P355; Qiagen, Valencia, Calif., catalog no. Q7), anti-phosphotyrosine antibodies (e.g., 4G10® available from Millipore, Billerica, Mass.), and anti-phosphoserine antibodies (also available from Millipore).

If the analyte of interest is coupled to a first member of an affinity pair, the mobility modifier that increases the mass of the analyte of interest can be the second member of the affinity pair. In some embodiments, the second member of the affinity pair is coupled to a detectable label, e.g., a fluorescent label, a radioactive label, a luminescent label or a colorimetric label. Non-limiting examples of such detectable labels include fluorescein, phycoerythrin, rhodamine, ³²P, ³⁵S, and ³H. In some embodiments, the second member of the affinity pair is coupled to an enzyme that can catalyze a reaction to induce its substrate to change color. One such non-limiting enzyme is horse radish peroxidase (HRP) (e.g., the HRP is coupled to the second member of the affinity pair). In this embodiment, the presence of the HRP (and thus the presence of the analyte of interest) can be detected using any number of colorimetric, fluorescent, and/or chemiluminescent substrates of HRP (e.g., those commercially available from Sigma-Aldrich Chemical Co, St. Louis, Mo.). This label can be used to facilitate detection of the mobility-modified analyte of interest.

If the analyte of interest is a nucleic acid, the mobility modifier that increases the mass of the analyte of interest can be a nucleic acid binding protein, a nucleic acid that is at least in part complementary to the analyte of interest (although the interaction with the analyte of interest is not limited to Watson-Crick base-pairing), a minor groove binder (e.g., distamycin) or an intercalator, a methylase, a polymerase or a ligase. The mobility modifier (in this case the partially or wholly complementary nucleic acid molecule that can hybridize to the nucleic acid of interest) can be detectably labeled (e.g., with a fluorescent label, a radioactive label, a luminescent label or a colorimetric label). Standard methods for labeling proteins and nucleic acid molecules are well known to the skilled artisan (see, e.g., Ausubel et al., Current Protocols in Molecular Biology, John Wiley and Sons, New York, N.Y. (including all updates through 2005)).

In some embodiments, the mobility modifier can alter the mobility of the analyte of interest by decreasing its mass. If the analyte of interest is a protein, the mobility modifier can recognize the specific amino acid sequence and catalyze a reaction, such as cleaving the peptide bond, resulting in two or more smaller fragments. The smaller molecular weight fragments are expected to migrate more rapidly (i.e., have higher mobility) as compared to the untreated analytes, when run in a PEC separation under non-orthogonal conditions. Non-limiting examples of such mobility modifiers include sequence specific proteases, such as trypsin, Factor Xa and enterokinase.

If the analyte of interest is a nucleic acid, the mobility modifier that decreases the mass of the analyte of interest can recognize a specific nucleotide sequence, nucleic acid type, nucleic acid structure or a nucleic acid junction, and then cleave the analyte of interest. Examples of such mobility modifiers include, but are not limited to, ribozymes (e.g., the hammerhead ribozyme), deoxyribozymes, and enzymes such as restriction enzymes, RNAses or DNAses.

In other embodiments, the mass of the analyte of interest can be decreased by first forming an analyte-complex with a complexing ligand, for example, by forming an affinity pair, prior to subjecting the sample to the first planar electrochromatographic separation. The sample is then treated to decomplex the analyte-ligand complex and thereby decrease the mass of the analyte of interest.

If the analyte of interest contains a labile bond, either naturally or by being covalently coupled to a mass tag having the labile bond, a mobility modifier that breaks this labile bond and thus reduces the mass of the analyte of interest can be used. Labile bonds and mobility modifiers that break these bonds are discussed in the context of isobaric peptide tags, although the same concepts apply to analysis of any analyte of interest that naturally or by design contains a labile bond.

In some instances, labile bonds can be broken with an acidic solution of vapor, for example hydrochloric acid, sulfuric acid, acetic acid, or formic acid.

In some instances, labile bonds can be broken with a basic solution of vapor, for example ammonia.

In some instances, labile bonds can be broken by application of heat, for example, from a heat source such as a heating plate or an oven.

Breakage of labile bonds can be achieved, for example, by placing the PEC matrix in an appropriate environment, such as in an acidic environment or a basic environment. Alternatively or in addition, a PEC matrix can be placed into proximity or inside a heat source, or in proximity of a light source.

In some instances, a labile bond is a photo-cleavable bond. Peptide-DNA conjugates (Olejnik et al. (1999) Nucleic Acids Res., 27:4626-31), synthesis of PNA-DNA constructs, and special nucleotides such as the photocleavable universal nucleotides of WO 00/04036 contain photocleavable bonds. Useful photocleavable linkages are also described by Marriott and Ottl (1998), Methods Enzymol. 291:155-75. Photocleavable bonds and linkages are useful in (and for use with) mass tags because they allows precise and controlled breakage of the mass tags (for subsequent detection) and/or precise and controlled release of mass tags from the analytes to which they are attached. A variety of photocleavable bonds and linkages are known and can be adapted for use in and with reporter signals. Recently, photocleavable amino acids have become commercially available. For example, an Fmoc protected photocleavable slightly modified phenylalanine (Fmoc-D,L-β-Phe(2-NO₂)) is available (Catalog Number 0011-F; Innovachem, Tucson, Ariz.). The introduction of the nitro group into the phenylalanine ring causes the amino acid to fragment under exposure to UV light (at a wavelength of approximately 350 nm). The nitrogen laser emits light at approximately 337 nm and can be used for fragmentation. The wavelength used will not cause significant damage to the rest of the mass tag or the analyte.

Fmoc synthesis is a common technique for peptide synthesis and Fmoc-derivative photocleavable amino acids can be incorporated into peptides using this technique. Although photocleavable amino acids are useful in any mass tag, they are particularly useful in peptide mass tags.

Use of photocleavable bonds is illustrated in the following examples. Analytes on a PEC plate may be directly measured from the plate using a MALDI source ion trap mass spectrometer.

A photocleavable bond also can be incorporated into a mass tag and used for breakage of the mass tag, resulting in the mobility modification of the analyte of interest in the disclosed methods.

In one embodiment, a photocleavable amino acid (such as the photocleavable phenylalanine) is incorporated at any desired position in a mass tag. A mass tag such as XXXXXXF*XXXXXX (where X is any amino acid) contains a phenylalanine (F*) that is photocleavable (e.g., L-4′-[3-(Triflourmethyl)-3H-diazirin-3-yl]phenylalanine, Baldini et al. (1998), Biochemistry 27:7951-7959). The mass tag can then be covalently coupled to an analyte of interest using methods described elsewhere herein. After the sample containing the analyte of interest is subjected to a first dimension PEC, the mass tag is fragmented using the appropriate wavelength of light as a mobility modifier. In this case, the tag XXXXXXFXXXXXX would be photocleaved by the mobility modifier (i.e., light) to yield the free analytic signal XXXXXX. The sample is then subjected to the second dimension PEC, where the free analytic signal and the analyte-of-interest-bound analytic signal migrate distinguishably. Optionally, the free analytic signal and/or the analyte-of-interest-bound analytic signal can be stained with a fluorescent dye, such as fluorescamine, prior to detection and/or quantitation by mass spectrometry.

In another embodiment, a tissue sample is contacted with an antibody having a mass tag attached via a photocleavable bond. Recognition of specific components within the sample allows for some of the antibody/mass tag conjugates to associate with antigens in the sample (excess conjugate is removed during subsequent wash steps). The sample is then subjected to the first dimension of PEC. The mass tags are then released from the analyte of interest by applying light (e.g., UV or near-UV light) as a mobility modifier. The sample is then subjected to PEC in the second dimension. The analytes of interest can be detected directly using the MALDI ion trap MS instrument. For example, a peptide mass tag of sequence CF*XXXXXXXXXXXXX (where F* is a modified phenylalanine) can be covalently coupled to an antibody via the sulfhydryl group of cysteine. Exposure to a UV source cleaves the tag at the modified phenylalanine residue, F*, releasing the XXXXXXXXXXXXX peptide from the tagged antibody. The released portion of the mass tag and/or the antigen/antibody of interest can subsequently can be detected and/or quantitated as described elsewhere herein.

Another example of the use of photocleavable bonds with reporter signals involves DNA-peptide chimeras used as mass tags. Such mass tags are useful as probes to detect particular nucleic acid sequences. In a DNA-peptide chimera (or PNA-peptide chimera), the peptide portion can comprise a mass tag. Placement of a photocleavable phenylalanine, for example, near the DNA-peptide junction of the mass tag allows for the release of a portion (the free analytic signal) of the mass tag by exposure to light (e.g., UV light) as a mobility modifier between the first and the second dimension of PEC. The released free analytic signal and/or the nucleic acid of interest with the analyte-bound portion of the analytic signal can be detected and/or quantitated as described elsewhere herein.

Photocleavable bonds can be broken using a variety of light sources as mobility modifiers. These mobility modifier light sources, include, but are not limited to, a laser (e.g., a nitrogen or Nd:YAG laser), a xenon lamp, an arc lamp or a UV lamp.

In some instances, the mobility of the analyte of interest in the second dimension can be modified by a mobility modifier that covalently or non-covalently couples the analyte of interest to the planar electrochromatography matrix. In one non-limiting example, where the analyte of interest comprises a phosphomonoester residue, a phosphomonoester-selective binding agent is coupled to the PEC matrix. In this example, the sample is subjected to PEC in a first dimension in the absence of a divalent cation (e.g., Zn²⁺, Mn²⁺, Co²⁺ or Ni²⁺). Then the addition of a mobility modifier, such as the addition of Zn²⁺, after the first dimension allows the analyte of interest to couple with the phosphomonoester-selective binding agent (where the phosphomonoester-selective binding agent is itself coupled to the matrix) during the second dimension PEC.

As discussed below, PEC can effect separation of analytes based on charge, mass, affinity to the matrix or a combination thereof. Thus, a mobility modifier may also change the charge of the analyte of interest. An example of such a mobility modifier is an agent that can oxidize sulfhydryl groups, for example bromine or sodium hypochloride, or an agent that cleaves the phosphodiester bond, for example, a phosphodiesterase or a basic solution.

A mobility modifier is not limited to a single substance. In some instances, an ion, a co-factor, a primer, ATP, and/or a nucleotide is used in addition to the mobility modifiers outlined.

Any agent or condition that selectively modifies the mobility of an analyte of interest is considered to be a mobility modifier within the scope of the invention.

It should be understood the mobility modifier may differ depending upon the analyte of interest. For example, if an analyte of interest is a glycoprotein or glycolipid, non-limiting mobility modifiers include lectins (e.g., concanavalin A, wheat germ agglutinin, or Phaseolus vulgaris lectin). If an analyte of interest is a carbohydrate, glycoprotein, or glycolipid, non-limiting mobility modifiers include lectins, glycosidases (e.g., endoglycosidase). If the analyte of interest is a lipid, then a non-limiting mobility modifier is a lipidase. If the analyte of interest contains a phosphorylated group, a phosphomonoester-selective binding agent (e.g., Phos-tag™) can be used to isolate selectively phosphorylated analytes of interest. Likewise, neuraminidase can be used to isolate sialic acid-containing analytes of interest. Specific antibodies can be used to isolate analytes of interest containing epitopes specifically recognized by the antibody. If analyte of interest is a nucleic acid, one possible mobility modifier is a protein capable of specific binding to a specific sequence in the nucleic acid of interest. Examples of such mobility modifiers include transcription factors. In some embodiments (a nucleic acid binding protein), the nucleic acid proteins include one or more motifs such as a zinc finger, helix turn helix, and a leucine zipper.

In one embodiment, the antibody itself is used as a mobility modifier. In this example, the analyte of interest is subjected to planar electrochromatography in a first dimension, then the antibody (the mobility modifier) is added and the analyte of interest is subject to planar electrochromatography in a second dimension. However, the binding of an antibody to its specific epitope is reversible. Thus, in another embodiment, the analyte of interest can be first contacted with an antibody, then subjected to planar electrochromatography in a first dimension. Then, e.g., the pH of the buffer is decreased (e.g., to a pH of less than 5.0 or less than 3.0), and then the analyte of interest is subjected to planar electrochromatography in a second dimension. The acidic solution (e.g., a buffer having a pH of less than 5.0 or less than 3.0) in this embodiment is the mobility modifier.

In yet another embodiment, a phosphomonoester-selective binding agent (e.g., a Phos-tag™ molecule) is used as a mobility modifier. In this embodiment, the analyte of interest is subjected to planar electrochromatography in a first dimension, then the phosphomonoester-selective binding agent (the mobility modifier) is added in the presence of a divalent cation (e.g., Zn⁺⁺ or Mn⁺⁺) and the analyte of interest is subject to planar electrochromatography in a second dimension. However, the binding of the phosphomonoester-selective binding agent to the phosphorylated analyte of interest is reversible. Thus, in another embodiment, the analyte of interest can be first contacted with a phosphomonoester-selective binding agent, then subjected to planar electrochromatography in a first dimension. Then, a divalent cation (e.g., Zn⁺⁺ or Mn⁺⁺ ions) are removed from the matrix using an ion chelating solution. Examples of ion chelating solutions include, but are not limited to, EDTA, EGTA, CDTA, N,N,N′,N′-tetrakis-(2-pyridylmethyl)-ethylenediamine (TPEN) and picolinic acid solutions. An ion chelating solution can be used to break up the interaction between the phosphomonoester-selective binding agent and its phosphomonoester residue target on the analyte of interest, and then the analyte of interest is subjected to planar electrochromatography in a second dimension. The ion chelating solution (e.g., an EDTA solution) in this example is the mobility modifier.

In another example, a chemical dephosphorylating agent is used as mobility modifier. Examples of such agents include, but are not limited to, hydrofluoric acid and hydrogen fluoride-pyridine.

In another embodiment, the mobility of an analyte of interest is modified by first immobilizing the analyte of interest to the stationary phase on a first planar electrochromatographic step and then releasing the analyte of interest from the stationary phase before or during the second planar electrochromatography step. For example, some of the reagents described herein (e.g., a phosphomonoester-selective binding agent, an antibody, and a nucleic acid fully or at least partially complementary to the nucleic acid of interest) can be coupled to the matrix of the planar electrochromatography. Once a sample containing (or suspected of containing) an analyte of interest is subjected to planar electrochromatography in the first dimension, it interacts with the reagent and is immobilized on the matrix. A mobility modifier then is added to release the analyte of interest from the reagent attached to the matrix. The sample is then subjected to planar electrochromatography in a second dimension. In these embodiments of the invention, the mobility-modifier will depend upon which reagent is coupled to the matrix.

For example, if the reagent coupled to the matrix is a nucleic acid that is at least partially complementary to the nucleic acid of interest, then the mobility modifier can be, for example, changing the temperature (e.g., increasing the temperature to cause the hybridized nucleic acid of interest to denature from the at least partially complementary nucleic acid coupled to the matrix, and decreasing the temperature will cause hybridization) and/or changing the salt concentration (e.g., reducing the salt concentration in the solution or buffer surrounding the matrix will cause the hybridized nucleic acid of interest to denature from the at least partially complementary nucleic acid coupled to the matrix, and increasing the salt concentration will cause hybridization).

The ordinarily skilled artisan can readily determine the temperature and amount of salt that may be required to either cause the hybridization of or cause the denaturation of (i.e., the unhybridization of) the nucleic acid of interest with the at least partially complementary nucleic acid coupled to the matrix by the sequence of the nucleic acid of interest and/or the nucleic acid coupled to the matrix (see, e.g., Ausubel et al., supra). In particular, the G (guanine) and C (cytosine) content is important for such a determination. It should be noted that in this example, if the first dimension can be performed in non-hybridizing conditions, then the mobility modifier is to change the conditions so that the second dimension is performed in hybridizing conditions. Likewise, if the second dimension is performed under hybridizing conditions, then the mobility modifier is to change the conditions so that the second dimension is performed in hybridizing conditions. Hybridization is a non-limiting form of a non-covalent bonding between complementary nucleotides.

The mobility of the analyte(s) of interest is modified after the first planar electrochromatographic separation. It will be apparent that mobility modification of the analyte of interest may occur in a separate step prior to or concurrent with the second planar electrochromatographic separation.

By way of example, if the mobility modifying agent is an acid or base, the acid or base may be introduced into the mobile liquid phase used in the second separation step.

### Isobaric Mass Tags

In some embodiments of the invention, analytes of interest are covalently coupled to a set of isobaric mass tags prior to being subjected two planar electrochromatography. Each isobaric mass tag in a set has the same overall mass as every other tag in the set and also contains a labile bond. In this instance, the mobility modifier breaks up the labile bond of the mass tag, which breaks up the mass tag into non-isobaric fragments. Non-isobaric fragments of the mass tags and the analytes of interest with a portion of the mass tag, now also non-isobaric, can be separated and distinguished in the second dimension of the planar electrochromatography.

The labile bond of the isobaric mass tag can be acid-labile, base-labile, heat-labile, or photo-labile (i.e., photocleavable). Based on the type of labile bond, an appropriate mobility modifier is chosen to break the labile bond while the sample is in the two-dimensional electrochromatography matrix. Examples of mobility modifiers that can break a labile bond in an isobaric mass tag include, but are not limited to, light, heat, acidic solution or vapor, and a basic solution or vapor.

In some embodiments, isobaric mass tags useful in the methods, kits and compositions described herein are peptides containing a labile peptide bond, with isotopically heavy and/or light amino acids distributed on either side of the amino acids comprising the labile peptide bond, as described, for example in U.S. Pat. No. 6,824,981. In some instances the position of the amino acids forming the labile peptide bond is altered relative to the other amino acids in the peptide to effect larger mass differences among the products upon breakage of the labile bond. A variety of labile bonds useful in peptide tags are known in the art. For example, aspartyl-proline and asparagine-proline bonds are readily broken under mild conditions.

Preferential breakage of aspartyl-prolyl (DP) peptide bonds can readily be achieved, as they are 8-20-fold more labile when exposed to dilute acids or elevated temperature than other aspartyl-X or X-aspartyl peptide bonds. For example, DP bonds can be selectively broken through exposure to dilute acid (e.g., 0.015 to 10% hydrochloric, acetic, or formic acid) and/or elevated temperature (e.g., 90-110° C.) for a relatively short period of time (e.g., 20 minutes to an hour). Facile gas-phase breakage of the DP peptide bond in matrix-assisted laser desorption time-of-flight mass spectrometry (MALDI-TOF MS) is also known. The DP bond can easily be broken, while the bulk of other amino acid peptide bonds, including the KP bond, are stable under conditions of either chemical/heat hydrolysis or mass spectrometric fragmentation. The selectivity of the MS fragmentation approach differs significantly from the cited acid- or heat-based breakage, however. For example, fast atom bombardment collision-induced dissociation (FAB-CID) data indicates that the XP bond (X=A, E, F, I or S) fragments easily under the mass spectrometric conditions, but is insensitive to the acid- or heat-mediated breakage. Thus, the acid- and heat-based breakages are considerably more selective than the mass spectrometry-based breakage, making the localization of DP bonds by the former methods relatively easy to accomplish.

In an alternative chemical approach, the labile bond in the isobaric mass tag can be asparagine-proline (NP) instead of DP. Peptides that contain this sequence undergo complete breakage at the NP amide bond after exposure to ammonia vapor or solution. Other N—X bonds wherein X═Y, Q, I, E, A, G, N or F will not exhibit any peptide bond breakage, whereas when X=L, T and S partial breakage may be observed, N residues not involved in chain-breakage are expected to undergo deamidation to D upon exposure to ammonia.

The presence of DP peptide bonds in engineered isobaric mass tags can readily be detected by non-orthogonal two-dimensional planar electrochromatography (2DPEC), wherein both dimensions of the separations are performed using the same or similar mobile phase conditions, but an intervening heating or acid treatment step is introduced between the two separations. Briefly, peptides are fractionated by a first dimension PEC. As an example, the peptide digest is spotted onto a silica 60 HPTLC plate and then components are separated with pH 4.7 buffer (n-butanol/pyridine/glacial acetic acid/water, 50:25:25: 900, v/v/v/v) in the first dimension. A potential of 300-400 V is applied across the plate, generating a current output of 20 mA in this setup, which is current limited. A constant pressure of 0.7 atmospheres is applied to the plate surface and the plate is cooled using a water circulator from beneath to prevent excessive heating due to the applied potential (Joule heating). After the first dimension separation is complete, the mobile phase solvent is then allowed to evaporate away. The dried solid phase is then exposed to an acidic solution or acid vapor in order to break the labile DP bond. Next, the second dimension PEC separation is performed in a perpendicular dimension from the first dimension separation using the same mobile phase. Alternatively, after the first dimension PEC separation, the mobile phase can be induced to evaporate away and the DP bond scission can be accomplished in the same step by exposure to heat in a convection oven, prior to performing the second dimension PEC. Breakage of the DP bond prior to the second dimension separation facilitates identification of the peptides labeled with the isobaric peptide mass tags. While the bulk of the peptides in the labeled sample migrate identically in both dimensions of the PEC separation, those that have been labeled with the isobaric mass tags are readily identified as they migrate away from this diagonal, primarily due to the decrease in their mass.

Peptides (or proteins) on the PEC plate can be visualized using, for example, an amine-derivatization fluorogenic reaction, with labels such as fluorescamine, o-phthaladehyde, 3-(4-carboxybenzoyl) quinoline-2-carboxaldehyde (CBQCA), naphthalene 2,3-dicarboxaldehyde or epicoccone (a.k.a. Deep Purple stain, GE HealthCare, Amersham, England). Sulfhydryl-reactive fluorogenic reactions should normally be avoided, as in some embodiments the isobaric peptide mass tags are directed to protein cysteine residues. In order to avoid complex peptide spectra arising from mass differences due to varying levels of dye substitution of peptides, it is useful to employ readily reversible covalent dyes, such as CBQCA or epicoccone to visualize the profiles on the chromatographic plates. Alternatively, noncovalent fluorogenic dyes, such as SYPRO Orange, SYPRO Red or SYPRO Tangerine dye (Molecular Probes/Invitrogen, Eugene, Oreg.) or even iodine vapor can be employed to visualize the peptides on the chromatographic plates. Ninhydrin, ninhydrin-cadmium and dansyl chloride can also be used for visualization of proteins or peptides.

Once peptides that have migrated away from the diagonal are identified, using for example a gel imaging device such as the ProXPRESS 2D imager (PerkinElmer, Boston, Mass.), they can be quantitated using a single-stage MS instrument, such as a MALDI-oTOF MS instrument, like the prOTOF 2000 MS instrument (PerkinElmer, Boston, Mass.). The mass differences among the different broken peptide tags are too small to result in migration differences during the second dimension PEC, but are readily detectable by MS.

An exemplary set of isobaric mass tags suitable for 2DPEC/MALDI-oTOF MS-based quantitative analysis of seven protein samples is presented in Table 1.

TABLE 1
Exemplary Isobaric DP Mass Tags

| | Peptide-bound | |
|---|---|---|
| Isobaric labels | analytic signal | Free analytic signal |
| Y-GGGGGGDPGGGGGG | R-GGGGGGD | PGGGGGG |
| Y-GGGGGGDPGGGGGG | R-GGGGGGD | PGGGGGG |
| Y-GGGGGGDPGGGGGG | R-GGGGGGD | PGGGGGG |
| Y-GGGGGGDPGGGGGG | R-GGGGGGD | PGGGGGG |
| Y-GGGGGGDPGGGGGG | R-GGGGGGD | PGGGGGG |
| Y-GGGGGGDPGGGGGG | R-GGGGGGD | PGGGGGG |

Y denotes a reactive group for the analyte and R denotes the analyte that the isobaric label is covalently attached to.
Boldface indicates isotopically heavy glycine residues.

In addition to the breakage of engineered mass tags, DP peptide bond breakage of certain native sequences is also expected, such as the scission of DP sequences found in fructose-1,6-bisphosphatase, the cellulosomal scaffoldin subunit from Clostridium thermocellum, and herpes simplex virus type 1 (HSV-1) glycoprotein D. One approach to distinguish between these native DP bonds and the DP bonds associated with the isobaric mass tags is to simply subject the untagged peptide mixture to the modified 2DPEC approach first and formally identify the spurious breakages prior to performing the mass tagging experiments.

A similar quantitation strategy can be accomplished using a labile NP bond with, for example, mass tags listed in Table 2. For these tags, the peptides are fractionated by a first dimension PEC, and the mobile phase solvent is allowed to evaporate away. The dried solid phase is then exposed to a basic solution or basic vapor, such as ammonia, in order to cleave the labile NP bond. Then, the second dimension PEC separation is performed as described above.

TABLE 2
Exemplary Isobaric NP Mass Tags

| | Peptide-bound | |
|---|---|---|
| Isobaric labels | analytic signal | Free analytic signal |
| Y-GGGGGGNPGGGGGG | R-GGGGGGN | PGGGGGG |
| Y-GGGGGGNPGGGGGG | R-GGGGGGN | PGGGGGG |
| Y-GGGGGGNPGGGGGG | R-GGGGGGN | PGGGGGG |
| Y-GGGGGGNPGGGGGG | R-GGGGGGN | PGGGGGG |
| Y-GGGGGGNPGGGGGG | R-GGGGGGN | PGGGGGG |
| Y-GGGGGGNPGGGGGG | R-GGGGGGN | PGGGGGG |

Y denotes a reactive group for the analyte and R denotes the analyte that the isobaric label is covalently attached to.
Boldface indicates isotopically heavy glycine residues.

Quantitative analysis of proteins by 2DPEC can also be performed by circumventing the mass spectrometer all together, for example by using an analytical imaging device instead. Table 3 provides exemplary isobaric mass tags suitable for quantitation by an analytical imaging device.

TABLE 3
Exemplary Non-Isotopic Isobaric DP Mass Tags

| | Peptide-bound | |
|---|---|---|
| Isobaric labels | analytic signal | Free analytic signal |
| Y-GGGGGGDPGGGGGG | R-GGGGGGD | PGGGGGG |
| Y-GGGGDPGGGGGGGG | R-GGGGD | PGGGGGGGG |
| Y-GGDPGGGGGGGGGG | R-GGD | PGGGGGGGGGG |
| Y-GGGGGGGGDpGGGG | R-GGGGGGGGD | PGGGG |
| Y-GGGGGGGGGGDPGG | R-GGGGGGGGGGD | PGG |

Y denotes a reactive group for the analyte and R denotes the analyte that the isobaric label is covalently attached to.

In some embodiments, the free analytic signal may migrate together (as is, for example, the case for mass tag in Table 2). In other embodiments, the free analtytic signals may be sufficiently different, e.g., of different mass, that they migrate distinguishly (as may be the case for mass tags in Table 3).

In one or more embodiments, the mass tags are not isobaric. By way of example, mass tags having labile bonds may be provided that provide free analytic signals of different properties, e.g., mass, so that they may be readily distinguished in a subsequent detection step.

### Coupling of Mass Tags to Analytes

Isobaric mass tags can be covalently coupled to proteins or peptides, or any other selected analyte. For example, for coupling of mass tags to amine groups of proteins or peptides, the chemically-reactive group may be an amine-reactive group, such as an NHS ester, a modified NHS ester, an imidoester, an isothiocyanate, or an acetylating agent. Non-limiting examples of acetylating agents include alpha-haloacetyls, such as iodoacetyl or iodoacetamide. For coupling of mass tags to sulfhydryl groups of proteins or peptides, the chemically-reactive group can be a sulfhydryl-reactive group, such as a thiol, an epoxide, a nitrile, a maleimide, a haloacetyl, or a pyridyl disulfide.

Coupling of mass tags to targets other than proteins or peptides is also possible. For example, coupling to diols of carbohydrates or lipids can be achieved by first oxidizing vicinal hydroxyls to an aldehyde or a ketone using NaIO₄ (sodium meta-periodate). For coupling to carbonyl groups, the carbonyl-reactive group can be a hydrazide or a hydrazine derivative. For coupling to carboxyl groups, the carboxyl-reactive group can be a carbodiimide, such as 1-ethyl-3-[3-dimethylaminopropyl]carbodiimide hydrochloride or dicyclohexylcarbodiimide.

The reactive group Y can also be a photo-reactive group, for example an aryl azide, such as phenyl azide, hydroxyphenyl azide, nitrophenyl azide, or tetrafluorophenyl azide.

Some of the chemically reactive groups described above are useful for coupling to more than one type of analyte, depending on the reaction conditions used for the coupling reaction. Further details regarding the coupling chemistry can be found in “Cross-Linking Reagents Technical Handbook,” available from Pierce Biotechnology (Rockford, Ill.), the disclosure of which is incorporated by reference herein in its entirety. Other chemistries and techniques for coupling compounds to analytes are known in the art and can be used to couple an isobaric mass tag to an analyte of interest.

### Assay with Isobaric Mass Tags

An exemplary assay for the selective isolation of one or multiple proteins or peptides labeled with isobaric mass tags by non-orthogonal two-dimensional planar electrochromatography (2DPEC) can be performed as follows. The mass tags possess a common mass-to-charge ratio that results in their co-migration during a first dimension planar electrochromatography separation. The masses of the mass tags are subsequently altered by chemical or heat treatment, while they are still inside the planar electrochromatography matrix, resulting in selective breakage of the labile peptide bond and the resulting altered forms of the mass tags can then be distinguished via differences in their mass-to-charge ratio during a second dimension of planar electrochromatography. The altered mass-to-charge ratio of the mass tags is readily detected in 2DPEC as the proteins or peptides with mass tags attached migrate off the diagonal line generated by the bulk of the proteins or peptides in the sample which lack the mass tag and consequently migrate in an identical manner in both dimensions. The mass tags and/or the proteins or peptides can subsequently be quantitated using a conventional single-stage mass spectrometer, such as a matrix-assisted laser desorption/ionization orthogonal time-of-flight mass spectrometer (MALDI-oTOF MS) or even by using an analytical gel imaging device after, for example, post-separation labeling with a fluorescent reagent, such as fluorescamine.

### Phosphomonoester-Selective Binding Agents as Mobility Modifiers

Non-limiting examples of phosphomonoester-selective binding agents are based upon 1,3-bis[bis(pyridin-2-ylmethyl)amino] propan-2-ol, a highly selective Zn(II) ion chelator operating at neutral pH. In some embodiments, selective binding of dinuclear Zn(II) Phos-tag™ complex to the phosphomonoester group of phosphoproteins and phosphopeptides instead of unphosphorylated peptides and proteins has been demonstrated. Thus, phosphomonoester-selective binding agents such as Phos-tag™ molecules can, therefore, be useful as mobility modifiers for phosphorylated proteins or peptides.

In some instances, a phosphomonoester-selective binding agent such as a Phos-tag™ molecule can be formed inside the planar electrochromatography matrix, by adding a Zn⁺⁺ or Mn⁺⁺ solution (or another divalent cation) to a phosphomonoester-selective binding agent covalently or non-covalently attached to the matrix (see Kinoshita et al. (2005), J. Sep. Sci. 28:155-162).

### Two-Dimensional Planar Electrochromatography Techniques

Exemplary systems and methods for separation of biomolecules, e.g., proteins, peptides, amino acids, oligosaccharides, glycans and even small drug molecules, using electroosmosis-driven planar chromatography are described in detail in U.S. Pub. No. US2005/0269267, which is incorporated herein by reference in its entirety. These systems and methods are useful for two-dimensional planar electrochromatography methods described herein.

In electroosmosis-driven planar chromatography an amphiphilic polymeric membrane, amphiphilic thin-layer chromatography plate or similar planar substrate provides the stationary phase for the separation platform. The planar substrate surface is characterized by a combination of charge carrying groups (ion exchangers), non-covalent groups (counterions), and nonionic groups that facilitate chemical interactions with the analyte. In a method for the separation of biomolecules using a planar electrochromatographic system, electroosmotic flow is generated by application of a voltage across the planar support in the presence of a miscible organic solvent-aqueous buffer mobile phase. Charged ions accumulate at the electrical double layer of the solid-phase support and move towards the electrode of opposite charge, dragging the liquid mobile phase along with them. Charged analytes are separated due to both the partitioning between the liquid phase and the solid phase support and the effects of differential electromigration.

In some embodiments, planar chromatography is carried out in two dimensions (2D); e.g., a first planar chromatographic separation is conducted in a first dimension, and a second planar chromatographic separation is conducted in a second dimension.

In some embodiments of two-dimensional planar electrochromatography, useful for performing methods described herein, upon completion of separation in one direction, e.g., the first dimension separation, the solid phase is rinsed, allowed to dry and treated with the mobility modifier under conditions to modify the mobility of the analyte of interest. The solid phase is then incubated in a second organic solvent-aqueous buffer mobile phase and then fractionated in a direction that differs from the original direction of separation (e.g., the second dimension separation). Typically, the second direction is perpendicular to the first direction.

In accordance with one or more embodiments, the two PEC separations are non-orthogonal.

Membranes useful in planar chromatography include polymeric sheets, optionally derivatized to provide the amphiphilic character of the planar stationary phase. Exemplary hydrophobic membranes for membrane-based electrochromatography of proteins and peptides include Perfluorosulfonic Nafion® membrane (Dupont Corporation), partially sulfonated PVDF membrane, sulfonated polytetrafluoroethylene grafted with polystyrene, polychlorotrifluoroethylene grafted with polystyrene, or the like. Sulfonation of polyvinylidene difluoride (PVDF) can be achieved by incubation with sulfuric acid at a moderately high temperature. The degree of sulfonation can be systematically varied, where ion exchange capability of 0.25 meq/g is considered as “moderate” sulfonation. In these membranes separation depends upon the electrostatic interaction of proteins with sulfonated residues in combination with hydrophobic interactions with aromatic residues in the substrate. At pH in the range from about pH 2.0 to about pH 11.0, the protonated primary amine groups on the proteins will interact with sulfonated residues on the membrane. This interaction is diminished at pH greater than about pH 11.0. Sulfonate residues will be protonated at a pH less than about pH 2.0 and will lead to a decline in the electroosmosis driving force of the separation.

In some embodiments, PVDF membranes, used for the isolation by electroblotting of proteins separated by gel electrophoresis, can be derivatized with cationic functional groups in order to generate an amphiphilic membrane (e.g., Immobilon-CD protein sequencing membrane (Millipore Corporation)). For example, PVDF membrane can be etched with 0.5 M alcoholic KOH and subsequently reacted with polyallylamine under alkaline conditions. As another example, PVDF membranes can be derivatized with diethylaminoethyl or quartenary ammonium residues.

In some embodiments, the membrane is unsupported. In other embodiments, the membrane is supported or semi-supported. For example, the membrane can be held between two rigid or semi-rigid holders in the form of frames with large openings in the center. The membrane may also be rigidly supported on a solid support, for example, a glass plate. Membranes may be substantially non-porous. In such instances, the mobile phase moves over the surface of the membrane. In other embodiments, the membrane may be porous, in which case the mobile phase moves through the pores and/or channels of the membrane. Separation occurs by preferential interactions of the proteins with the hydrophobic surfaces or the interstitial surfaces of the membrane.

As another example, a planar stationary phase useful for separation of analytes include silica thin-layer chromatography plates derivatized with alkyl groups (e.g., C₃-C₁₈ surface chemistry), aromatic phenyl residues, cyanopropyl residues or the like. In these instances, the silanol groups provide the ion exchange qualities of the amphiphilic support and can be deprotonated at a pH of 8, leading to electroosmosis and thereby providing the ion exchange qualities of the amphiphilic support. At pH values below 3, there will be a reduction or elimination in electroosmosis. In some embodiments, both hydrophobic groups, e.g., alkyl, and charged groups, e.g., sulfonic acid, can be attached to the same silica particle. As a further example, a stationary phase support for the separation of analytes by planar electrochromatography includes a gamma-glycidoxypropyltrimethoxysilane sublayer attached to the silica support of a thin-layer chromatography plate. A sulfonated layer is then covalently affixed between the sublayer and an octadecyl top layer. For separation of analytes such as proteins in the 10 and 100 kDa range using a silica-based stationary phase, it is expected that derivatization with C₈ and C₄ groups, respectively, may be used. Phenyl functionalities are slightly less hydrophobic than C₄ functionalities and may be advantageous for the separation of certain analytes.

The planar stationary phase includes pores or connected pathways of a dimension that permits unimpeded migration of the analytes. For particulate stationary phases, such as silica thin-layer chromatography plates or particulate-based polymer membranes, the stationary phase consists of particles that form pores of about 30-100 nanometers in diameter, although for some smaller analytes with molecular weights of 2,000 daltons or less, 10 nanometers pores may be acceptable. Typical absorbants commercially available for thin-layer chromatography are made of particles that form pores sizes of only 1-6 nm, which precludes effective use for some analyte separations. The particles may have a diameter of about 3-50 microns, with the smaller diameter particles typically producing higher resolution analyte separations. For higher analyte loads, large particle absorbents are preferable. This is particularly advantageous for the preparative scale isolation of analytes. The size distribution of the particles should be relatively narrow and particles are preferably spherical, rather than irregularly shaped. While the base material of the particles can be silica, synthetic polymers, such as polystyrene-divinylbenzene (or any of the above mentioned hydrophobic polymers) are also expected to be appropriate. Pore sizes and particle sizes may vary and may be larger or smaller than those discussed herein dependent on the size of the analytes investigated.

Besides particulate thin-layer chromatography substrates, large pore mesoporous substrates, grafted gigaporous substrates, gel-filled gigaporous substrates, nonporous reversed phase packing material, and polymeric monoliths should be applicable to PEC of peptides and proteins. Preconditioning of TLC/HPTLC plates has been well documented and is routinely followed in QA/QC laboratories for separation of a variety of analytes. In order to obtain reproducible results, precoated plates should be heated to >100° C. and stored in a desiccating chamber before using them. This provides uniform moisture content and reproducibility. General applicability of plate preconditioning to PEC is not fully defined as of yet and cellulose plates are not typically subjected to a preconditioning step.

The liquid mobile phase typically includes an organic phase and an aqueous phase. Exemplary mobile phases include methanol-aqueous buffer, acetonitrile-aqueous buffer, ethanol-aqueous buffer, isopropyl alcohol-aqueous buffer, butanol-aqueous buffer, isobutyl alcohol-aqueous buffer, propylene carbonate-aqueous buffer, furfuryl alcohol-aqueous buffer systems or the like. The basic principles of electrochromatography provide the foundation for systematic selection of stationary phase supports, mobile phase buffers and operating conditions, and allow for the adaptation of the technology to a broad range of applications in proteomics, drug discovery and the pharmaceutical sciences. Mobile phases rich in organic modulators will exhibit relatively little chromatographic retention and in mobile phases low in organic modulator, chromatographic retention will dominate the separation process. The mobile phase may also include a surfactant, for example, when it is desired for the mobile phase to include micelles or a micro-emulsion. See, e.g., U.S. Ser. No. 11/636,327, for further details.

The isoelectric point or net charge of the analytes at a given pH value and the extent of hydrophobicity/hydrophilicity can be used to determine the optimum mobile phase to be used in the analytic separation. The liquid mobile phase can be a purely aqueous or an aqueous mixture containing a water miscible organic liquid.

In some embodiments, the liquid mobile phase may be a methanol-aqueous buffer; acetonitrile aqueous buffer; ethanol-aqueous buffer; isopropyl alcohol-aqueous buffer; butanol-aqueous buffer; isobutyl alcohol-aqueous buffer; carbonate-aqueous buffer, or any of a wide range of other buffer systems found suitable for separation of analytes HPLC or CEC. Mobile phases rich in organic modulators will exhibit relatively little chromatographic retention and in mobile phases low in organic modulator, chromatographic retention will tend to dominate the separation process. Different cathode and anode buffers can be used as a discontinuous buffer system for the separation of analytes by PEC. In fact, the stationary phase could be incubated in a buffer that is compositionally different from either electrode buffer. Additives, such as carrier ampholytes may also be included in the buffer in which the stationary phase is incubated. Finally, the composition of the mobile phase may be altered temporally to provide a composition gradient that facilitates separation of analytes. In 2D separation of analytes by PEC, the sample may be applied to the center of the TLC plate (dry or pre-wetted with mobile phase) or elsewhere on the plate, should certain knowledge regarding extent of migration and direction already be available. The stationary phase may then be incubated in a mobile phase and an electrical potential applied. The liquid mobile phases can be adjusted to different pH values, concentrations of organic solvent, and ionic strengths to facilitate 2D separations of analytes by PEC.

In one embodiment of two-dimensional planar electrochromatography, the concentrations of organic modulators in liquid mobile phases are in the range of about 0% to about 60%.

In another embodiment, the ionic strength of liquid mobile phases can be from about 2 mM to about 150 mM. Exemplary liquid mobile phase formulations include 20 mM ammonium acetate, pH 4.4, 20% acetonitrile; 2.5 mM ammonium acetate, pH 9.4, 50% acetonitrile; 25 mM Tris-HCl, pH 8.0/acetonitrile (40/60 mix); 10-25 mM sodium acetate, pH 4.5, 55% acetonitrile; 60 mM sodium phosphate, pH 2.5/30% acetonitrile; 5 mM borate, pH 10.0, 50% acetonitrile; 5-20 mM sodium phosphate, pH 2.5, 35-65% acetonitrile; 30 mM potassium phosphate, pH 3.0, 60% acetonitrile and 10 mM sodium tetraborate, 30% acetonitrile, 0.1% trifluoroacetic acid; 20% methanol, 80% 10 mM MES, pH 6.5, 5 mM sodium dodecyl sulfate; 20% methanol, 80% 10 mM MES, pH 6.5, 5 mM sodium phosphate, pH 7.0/methanol (4:1, v/v); 4 mM Tris, 47 mM glycine, pH 8.1; 20 mM sodium phosphate, pH 6.0, 150 mM NaCl; 20 mM Tris-HCl, pH 7.0, 150 mM NaCl; 5 mM sodium borate, pH 10.0; or the like.

Proteomics studies are often based upon the comparison of different protein profiles. The central objective of differential display proteomics is to increase the information content of proteomics studies through multiplexed analysis. Currently, two principal gel-based approaches to differential display proteomics are being actively pursued, difference gel electrophoresis (DIGE) and Multiplexed Proteomics (MP). In one embodiment in accordance with the present invention, planar electrochromatography can be used with difference gel electrophoresis (DIGE) to increase the information content of proteomics studies through multiplexed analysis. Succinimidyl esters of the cyanine dyes (e.g., Cy2, Cy3 and Cy5) can be employed to fluorescently label as many as three different complex protein populations prior to mixing and running them simultaneously on the same 2D gel using DIGE. Images of the 2D gels are acquired using three different excitation/emission filter combinations, and the ratio of the differently colored fluorescent signals is used to find protein differences among the samples. DIGE allows two to three samples to be separated under identical electrophoretic conditions, simplifying the process of registering and matching the gel images. DIGE can be used to examine differences between two samples (e.g., drug-treated-vs-control cells or diseased-vs-healthy tissue). A benefit of the herein-described technology with respect to DIGE is that protein separations can be achieved more quickly and samples are more readily evaluated by mass spectrometry after profile differences are determined. One requirement of DIGE is that from about 1% to about 2% of the lysine residues in the proteins be fluorescently modified, so that the solubility of the labeled proteins is maintained during electrophoresis. Very high degrees of labeling can be achieved when separations are performed by the planar electrochromatography technique, due to the fact that organic solvents are employed in the mobile phase and sample buffers. High degrees of labeling should in turn dramatically improve detection sensitivity using the DIGE technology.

In some embodiments of two-dimensional separation of analytes on an amphiphilic stationary phase using planar electrochromatography, a sample is applied on the center of the membrane (dry or pre-wetted with mobile phase) and the planar stationary phase is then incubated in a mobile phase. Once the analytes are electrophoretically separated in one direction, the planar stationary phase is washed and incubated in a second mobile phase, and then electrophoretically separated in a direction perpendicular to the first direction.

Analyte samples can be prepared for two-dimensional planar electrochromatography by first dissolving the analytes in a sample buffer. In one embodiment, a sample buffer is the mobile phase or a weaker solvent of lower ionic strength. In some embodiments, a sample buffer is one of “biological buffers”, such as Good's buffers. These biological buffers produce lower currents than inorganic salts, thereby allowing the use of higher sample concentrations and higher field strengths. Exemplary Good's buffers include N-(2-Acetamido)-2-aminoethanesulfonic acid (ACES), N-(2-Acetamido)iminodiacetic acid (ADA), N,N-Bis(2-hydroxyethyl)-2-aminoe-thanesulfonic acid (BES), N,N-Bis(2-hydroxyethyl)glycine (BICINE), Bis(2-hydroxyethyl)iminotris(hydroxylmethyl)methane (BIS-TRIS), N-Cyclohexyl-3-aminopropanesulfonic acid (CAPS), N-Cyclohexyl-2-hydroxy-3-aminopropanesulfonic acid (CAPSO), N-Cyclohexyl-2-aminoethanesulfonic acid (CHES), 3-[N,N-Bis(hydroxyethyl)amino]-2-hydroxypropanesulfonic acid (DIPSO), 3-[4-(2-Hydroxyethyl)-1-piperazinyl]propanesulfonic acid (EPPS), 2-[4-(2-Hydroxyethyl)-1-piperazinyl]ethanesulfonic acid (HEPES), 2-Hydroxy-3-[4-(2-hydroxyethyl)-1-piperazinyl]-propanesulfonic acid, monohydrate (HEPPSO), 2-Morpholinoethanesulfonic acid, monohydrate (MES), 3-Morpholinopropanesulfonic acid (MOPS), 2-Hydroxy-3-morpholinopropanesul-fonic acid (MOPSO), piperazine-1,4-bis(2-ethanesulfonic acid) (PIPES), piperazine-1,4-bis(2-ethanesulfonic acid), sesquisodium salt (PIPES, sesquisodium salt), piperazine-1,4-bis(2-hydroxy-3-propanesulfonic acid), dehydrate (POPSO), N-Tris(hydroxymethyl)methyl-3-aminopropanesulfonic acid (TAPS), N-Tris(hydroxymethyl)methyl-2-hydroxy-3-aminopropanesulfonic acid (TAP SO), Tris-(hydroxymethyl)aminomethane (TRIS), N-Tris(hydroxymethyl)methyl-2-aminoethanesulfonic acid (TES), and N-[Tris(hydroxymethyl)methyl]glycine (TRICINE). If salts are used to facilitate extraction and isolation of the analyte specimen, desalting of analyte samples may be performed using reverse phase resins by organic solvent-based analyte precipitation or by sample dialysis prior to sample fractionation by planar electrochromatography.

In some embodiments, analyte samples are prepared for two-dimensional planar electrochromatography by first dissolving the analytes in HPLC solvent systems thereby avoiding the use of detergents, chaotropes and strong organic acids for analyte dissolution.

HPLC solvent systems include buffered solutions containing organic solvents, such as methanol or acetonitrile, may be employed to prepare the biological specimens. For example, 60% methanol or acetonitrile, 40% water containing 0.1% formic acid or 60% methanol or acetonitrile, 40% 50 mM ammonium carbonate, pH 8.0 are suitable sample solubilization buffers.

In one embodiment, final analyte concentration in the solubilization buffer is from about 0.05 mg/ml to about 5 mg/ml. In another embodiment, final analyte concentration in the solubilization buffer is from about 0.4 mg/ml to about 0.6 mg/ml. Extraction and solubilization of analytes can be facilitated by intermittent vortexing and sonication. Surfactants are well known to suppress peptide ionization in mass spectrometry and also to interfere with chromatographic separations, particularly with reversed-phase liquid chromatography. Buffered solutions containing organic solvents are more compatible with liquid chromatography and mass spectrometry and thus facilitate characterization of the analytes after they have been subjected to planar electrochromatography. Another important advantage of the buffered organic solvent extraction procedure is that it facilitates solubilization, separation and identification of analytes such as integral membrane proteins, including proteins containing transmembrane-spanning helices.

Various spot volumes, sizes, and shapes can be used in PEC. In some embodiments, TLC plates used for PEC are dried with nitrogen after spotting. In some embodiments, spots confined to a minimum size (about 2 mm in diameter) to provide better resolution. Streaking may occur if the sample is overloaded. Typically, cellulose plates can separate up to 100 mg of sample material. A variety of devices designed for dispensing a sample on to TLC plates can be used. These dispensers can be manual or automated. For example, the manual dispenser can be a pipette, piezo-electric dispensing tip, solid pin, or quill pin. Automated dispensing may be achieved using general purpose liquid handling robotics or dedicated liquid handlers developed specifically for the task, such as the Automatic TLC Sampler (ATS 4; Camag, Muttenz, Switzerland). Care has to be taken to wet the plate so that there is no flooding and the spotted area does not spread out. For example, when wetted correctly, the cellulose plate appears dull gray, while a plate that is overly wet will appear glossy. Whatman 3MM or equivalent filter paper, devoid of any impurities, can transfer the buffer at a nominal rate, minimizing diffusion that can lead to band broadening and streaking. Also, if the size of the wick extends beyond the plate area or overlaps the plate more than a couple of centimeters, buffer may accumulate at the edges of the plate causing diffusion.

As the TLC sheets have a very thin coating of the stationary phase, the mobile phase has a tendency to rise up to the surface due to capillary action. In some embodiments, pressurizing the plate counteracts this and leads to a better resolution. Attempts to perform PEC without plate pressurization are, in some embodiments, less efficient and of lower resolution than when pressure is applied to the plate during the electrophoretic/electroosmotic stages of these separations. Without pressurization, there is some degree of solvent evaporation and it also appears that with pressurization, there is a more constant level of solvent permeation throughout the cellulose or silica based TLC plates. However, simply using a covered sorption layer may be sufficient to ameliorate problems associated with evaporation. The evaporation of the mobile phase during PEC can result in decreased current, drying of the surface, and subsequent degradation in the quality of the separation, leading to overall poor reproducibility of the method. The degree of pressurization can be varied from run-to-run, if so desired, until optimum resolution and spot shapes are realized. This is sometimes optimized by a trial-and-error approach, but recommended pressures to be applied when beginning with the CBS Scientific HTLE apparatus are suggested by the manufacturer.

In some embodiments, planar electrochromatographic separation analytes is performed by directly applying an electric field across the membrane or thin layer chromatography plate. In one embodiment, the planar surface is interfaced with the electrical system through the use of wicks, also referred to as buffer strips. A wick is a solid or semisolid medium used to establish uniform electrical paths between the planar solid phase and the electrodes of a horizontal electrophoresis apparatus. For example, a wick may be composed of cellulose-based filter paper, Rayon fiber, buffer-impregnated agarose gel, moistened paper towel, or the like.

Application of an electric field in electrochromatographic systems could result in Joule heating which in turn could to lead to evaporation of liquid mobile phase from the membrane or plate surface. The evaporation of the mobile phase could result in decreased current, drying of the surface, and subsequent degradation in the quality of the separation. In one embodiment in accordance with the present invention, the planar stationary phase is covered with a glass plate, silicone oil or other impermeable barrier to reduce the evaporation of the mobile phase as a result of Joule heating. Further, flow of the mobile phase across the membrane or plate may be impeded in the forward direction, causing the electroosmotic flow to drive the liquid mobile phase to the surface of the membrane or plate. This can result in poor resolution separations and arcing of the electrophoretic device. Adjusting mobile phase pH or ionic strength will aid in optimizing conditions for the electrically driven separation. In one embodiment, operating current for analyte separations is from about 10 μA to about 500 mA and the electric field strength applied to the separation is from about 50 volts/cm to about 900 volts/cm. In another embodiment, the electric field strength applied to the separation is from 200 volts/cm to about 600 volts/cm. In certain embodiments of the present invention, separations of analytes can be performed using constant voltage, constant current or constant power mode, the latter resulting in constant amount of Joule heating in the system.

In some embodiments, after the analytes have been subjected to planar electrochromatography in the second dimension, MALDI-TOF MS can be used for direct analysis of analytes. In this embodiment, analytes of interest are fractionated on solid phase supports in the second dimension followed by direct probing with MALDI-TOF laser. In one embodiment, an orthogonal MALDI-TOF mass spectrometer (e.g., PrOTOF 2000 PerkinElmer, Boston, Mass., USA/MDS Sciex, Concord, ON, Canada) can be used to quantitate the analytes of interest. The prOTOF 2000 MALDI O-TOF mass spectrometer is a MS MALDI with orthogonal time of flight technology. The prOTOF's novel design provides improved instrument stability, resolution, and mass accuracy across a wide mass range compared with conventional linear or axial-based systems. The more accurate and complete analyte identification achieved with the prOTOF 2000 reduces the need for peptide sequencing using more complicated tandem mass spectrometry techniques such as Q-TOF and TOF-TOF. The instrument is particularly well suited for combination with planar electrochromatography because the MALDI source is decoupled from the TOF analyzer. As a result, any discrepancies arising from the solid phase surface topography or differential ionization of the sample from the surface are eliminated before the sample is actually delivered to the detector. The presentation of the analytes bound to a solid phase surface facilitates removal of contaminating buffer species and exposure to analyte breakage reagents (e.g., trypsin for proteins, restriction enzymes for DNA) prior to analysis by mass spectrometry. The use of HPLC-based buffers in the fractionation process minimizes the potential for downstream interference by detergents and chaotropes during mass spectrometry-based analysis.

Two-dimensional planar electrochromatography can be followed by direct analysis of analytes with MALDI-TOF MS by providing analytes conveniently affixed to solid phase supports and thus suitably presented for direct probing by the MALDI-TOF laser.

Analytes may be detected after they have been subjected to planar electrochromatography using a variety of detection modalities well known to those skilled in the art. Exemplary strategies employed for general analyte detection include organic dye staining, silver staining, radio-labeling, fluorescent staining (pre-labeling, post-staining), chemiluminescent staining, mass spectrometry-based approaches, negative-staining approaches, contact detection methods, direct measurement of the inherent fluorescence of analytes, evanescent wave, label-free mass detection, optical absorption and reflection, or the like. In negative-staining approaches, the analytes remain unlabeled, but unoccupied sites on the planar surface are stained. In contact detection methods, another membrane or filter paper that has been imbibed with a substrate is placed in contact with the planar surface and analyte species resident on the planar stationary phase interact with the substrate molecules to generate a product. In direct measurement of the inherent fluorescence of analytes, solid-phase supports of low inherent fluorescence are used. Exemplary detection methods suitable for revealing protein post-translational modifications include methods for the detection of glycoproteins, phosphoproteins, proteolytic modifications, S-nitrosylation, arginine methylation and ADP-ribosylation. Exemplary methods for the detection of a range of reporter enzymes and epitope tags include methods for visualizing β-glucuronidase, β-galactosidase, oligohistidine tags, and green fluorescent protein. For optimal performance of these detection technologies, solid-phase supports of low inherent fluorescence can be used.

Analyte samples that have undergone planar electrochromatography appear as discrete spots on the strip that are accessible to staining or immunolabeling as well as to analysis by various detection methods. Exemplary detection methods include mass spectrometry, Edman-based protein sequencing, or other micro-characterization techniques. In some embodiments, analytes bound to the surface of the membrane are labeled by reagents, such as, antibodies, peptide antibody mimetics, oligonucleotide aptamers, quantum dots, Luminex beads or the like.

In some embodiments, chemiluminescence-based detection of analytes on planar surfaces are used prior to or after fractionation by planar electrochromatography. In one embodiment, analytes are biotinylated and then detected using horseradish peroxidase-conjugated streptavidin and the Western Lightning Chemiluminescence kit (PerkinElmer). In another embodiment, analytes are fluorescently stained or labeled and the fluorescent dye subsequently chemically excited by nonenzymatic means, such as the bis(2,4,6-trichlorophenyl)oxalate (TCPO)—H₂O₂ reaction.

In some embodiments, the peptides or proteins remain unlabeled, but the planar surface itself contains a fluorescent indicator that is detected. The protein or peptide is visualized as a shadow against the fluorescent background. Ultraviolet light-excitable F254 and F366 fluorescent TLC plates are commercially available. Ninhydrin-stained peptides may readily be imaged from cellulose TLC plates through negative imaging of the low fluorescence background of the plates. Typically, the plates are excited using a xenon-arc lamp source with 480 nm excitation bandpass filter and fluorescent signal is collected with a 530 nm emission bandpass filter. The ProXPRESSw 2D Proteomic Imager (PerkinElmer, Boston, Mass.) provides the requisite capabilities for this type of imaging.

In some embodiments, proteins are biotinylated and then detected using horseradish peroxidase conjugated streptavidin (HRP-streptavidin) and standard Western blotting chemiluminescence kits. The TLC plate itself serves as a mechanically strong support, allowing archiving of the separation profiles without the need for vacuum gel drying, as required with conventional polyacrylamide gels. Other approaches to performing phosphopeptide and phosphoprotein analysis are also possible, not requiring the use of radiolabels or their emission counters. For example, the Pro-Qw Diamond phosphoprotein stain (Molecular Probes) can detect phosphoproteins in polyacrylamide slab gels, on polymeric membranes used for electroblotting, and on protein microarrays through a mechanism that combines a fluorescent metal ion-indicator dye and a trivalent transition metal cation titrated to acidic pH value. The stain has also been adapted to phosphate-based quantitation of phosphoproteins and phosphopeptides from solution and detection of phosphopeptides by high performance liquid chromatography. The staining technique is rapid, simple to perform, readily reversible, and fully compatible with analytical procedures such as MALDI-TOF mass spectrometry.

In some embodiments, detection of phosphorylated peptides is performable by standard immunostaining procedures using phosphoamino acid and phosphorylation state-specific antibodies. Analogous immunostaining procedures have already been devised for the detection of specific oligosaccharides, phospholipids, and glycolipids after TLC. Finally, based upon successful direct detection of phosphoproteins on electroblot membranes, it is likely that laser ablation inductively-coupled plasma mass spectrometry (ICP-MS) can be employed to directly measure phosphorous as an m/z 31 signal liberated from phosphoproteins or phosphopeptides displayed on PEC or TLE plates, without the use of radiolabels or surrogate dyes and antibodies.

Separations of analytes, using two-dimensional planar electrochromatography, can be achieved in a short duration. Analytes are spotted on a planar substrate, subjected to first dimension separation, rinsed, treated with a mobility modifier, and subjected to second dimension separation thereby providing access to the analytes on the surface of the stationary phase for detection. In one embodiment, SYPRO Ruby protein blot stain (Molecular Probes) is capable of detecting proteins on a surface within about 15 minutes. Additionally, the planar support itself serves as a mechanically strong support, allowing archiving of the separation profiles without the need for vacuum gel drying.

### Kits

The invention also provides kits for isolating an analyte of interest by two-dimensional PEC. In some embodiments, a kit comprises a matrix for use in 2DPEC, a mobility modifier, and a set of instructions for use. Any matrix described herein that is suitable for 2DPEC can be used. A kit can further comprise one or more mobile phases useful for 2DPEC.

Any suitable mobility modifier described herein can be used in a kit including, but not limited to, an antibody, a phosphomonoester-selective binding agent, a protease, a nuclease, an glycosidase, a lipase, kinase, a nucleic acid molecule, a nucleic acid binding protein, an acidic solution or vapor, a basic solution or vapor, a solution containing a divalent ion (such as Zn²⁺ or Mn²⁺), a peptide, a protein, a member of an affinity pair, a light source, a heat source, a cooling source, and any combinations thereof.

In some embodiments, the kit further comprises a set of isobaric mass tags. Optionally, the kit further comprises one or more reference analytes labeled with one or more mass tags, which can be used, for example, for reference or calibration purposes. Examples of reference analytes include, but are not limited to, a protein (including a phosphoprotein), a peptide (including a phosphopeptide), an antibody, a nucleic acid, a fatty acid, a glycan, or a lipid.

### Applications of the Invention

A. Biological and Pharmacological Applications

The methods, kits and compositions described herein are applicable to the study of a variety of normal and pathological physiological processes. Exemplary processes include, but are not limited to, onset of states of inflammation, growth, differentiation, apoptosis and the like, in organs and tissues of the body. For illustrative purposes, inflammatory changes in endothelial cells are examined. Endothelial cells represent the largest organ of the body, functioning as a semi-selective barrier between plasma and the interstitium. Acute loss of endothelial barrier function is a significant cause of tissue pathology and loss of organ function. Inter-endothelial junctions form the primary route for the passage of fluid and solutes, as well as for cell transmigration between the intravascular compartment and the interstitium. Kinetically-resolved and temporally-correlated proteomics and imaging measurements are required to fully understand vascular permeability. Proteomics efforts that concentrate only on the endothelial proteome at “time zero” and then at “time infinity”, will completely miss a host of intermediate protein and peptide interactions that are crucial to inflammation-induced barrier dysfunction.

The disclosed experimental design strategy utilizes kinetically resolved proteomics, physiomics, and metabolomics experiments, with a goal to “connect-the-dots” of proteomics efforts into an internally consistent mechanistic understanding of vascular permeability changes. It is expected that this detailed understanding of vascular permeability will provide insight into the molecular basis of vascular inflammation as it relates to a variety of diseases, will identify targets for new therapeutic interventions and will lead to new methods for early detection and diagnosis of diseases.

B. Environmental Applications

The methods, kits and compositions described herein are applicable to the study of analytes present in a variety of environmental sources. Exemplary environmental sources include lakes, rivers, oceans, rocks, soil, and air.

C. Industrial Applications

The methods, kits and compositions described herein are applicable to the study of a variety of industrial sources. Exemplary industrial sources include, but are not limited to, sewage, waste, exhaust, or a pollution source.

Other industrial applications of the methods, kits and compositions described herein include quality control and regulatory compliance.

### EXAMPLES

### Example 1

### Multiplex Assay with Isobaric Peptide Mass Tags

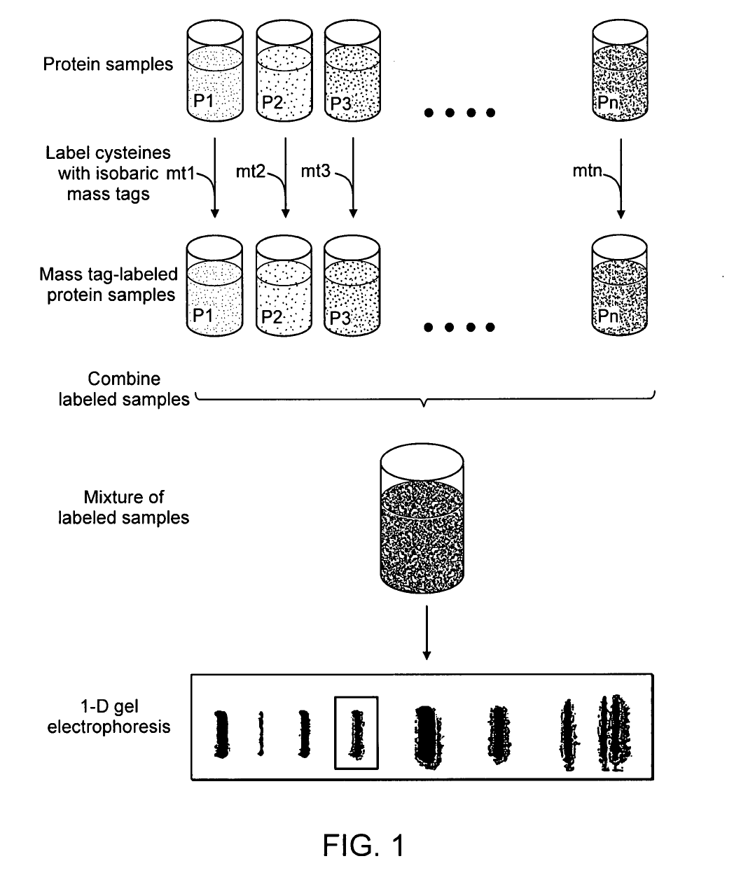

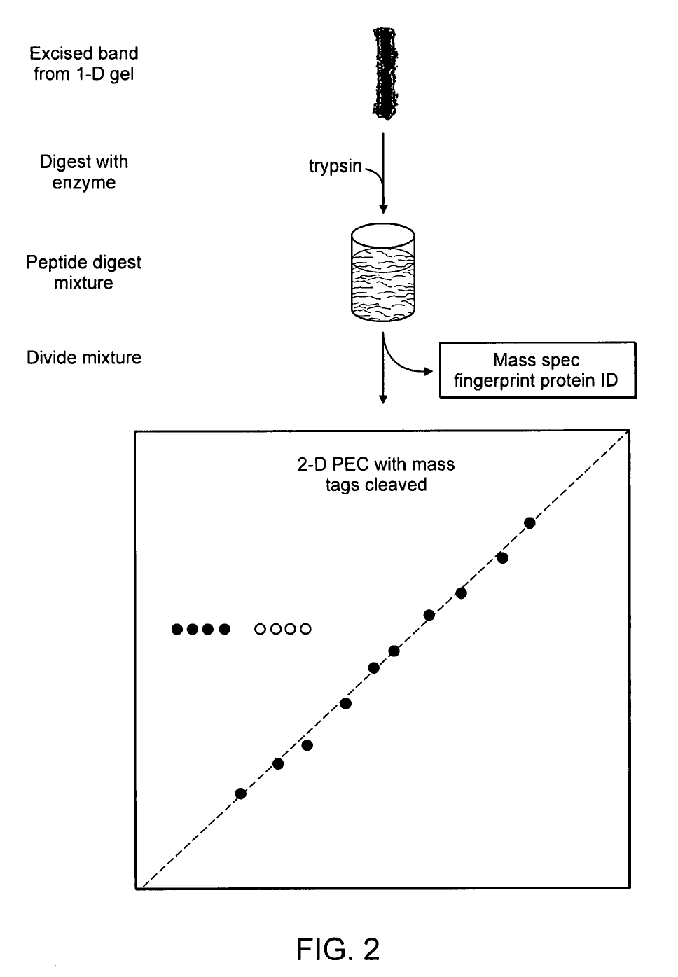

An exemplary workflow based upon the isobaric mass-tags, wherein analytes are proteins, is illustrated in FIGS. 1 and 2. As shown in FIG. 1, the samples are labeled with isobaric mass tags (mt1 . . . mtn), combined and proteins are then fractionated by one-dimensional (1-D) SDS-polyacrylamide gel electrophoresis. As shown in FIG. 2, one or more proteins or peptides of interest is selected from the electrophoretic profile, excised, proteolytically digested, for example with trypsin, and eluted from the gel slice by standard methods (e.g., Sambrook et al., Molecular Cloning: A Laboratory Manual, Cold Spring Harbor Laboratory Press; 3rd Ed. 2001, incorporated herein by reference in its entirety). A portion of the proteolytic digest can be used to identify the protein by peptide mass profiling or other standard identification techniques. The remainder of the eluted peptides is fractionated by a first dimension PEC, and the mobile phase solvent is allowed to evaporate away. The dried solid phase is then exposed to an acidic solution or acid vapor in order to cleave the labile DP bond. Then, the second dimension PEC separation is performed in a perpendicular direction from the first dimension separation. As in the mass spectrometry-based approach, breakage of the DP bond prior to the second dimension separation facilitates identification of the peptides labeled with the isobaric peptide mass tags. While the bulk of the peptides in the labeled sample migrate identically in both dimensions of the PEC separation, those that have been labeled with the isobaric mass tags are readily identified as they migrate away from this diagonal, primarily due to the decrease in their mass. Peptides on the PEC plate are visualized using an amine-derivatization fluorogenic reaction. However, the individual broken mass tags are engineered to differ by two glycine residues (114 daltons), resulting in mass differences among the different broken peptide tags that are large enough to result in migration differences during PEC. Higher resolution PEC separations can use tags differing by only one glycine residue, resulting in 57 Da mass differences, while lower resolution PEC separations can exploit tags differing by three glycine residues, resulting in 171 Da mass differences. The individual members of the train of fluorescent spots corresponding to the broken mass tags are visualized and subsequently quantitated using, for example, a fluorescent gel imaging device such as the ProXPRESS 2D imager (PerkinElmer, Boston, Mass.) and accompanying analysis software. Once again, both the peptide-bound analytic signal and the free analytic signal can be quantitated in this manner. While baseline resolution of the individual spots generated by the breakage of the mass tags is highly desirable, spots that are not baseline resolved can be quantitated nevertheless by standard deconvolution software routines practiced for the analysis of 2D gels. As depicted in Table 3, the heavy isotopes of glycine need not be utilized to distinguish among the different labeled samples. The engineered mass tags can be readily distinguished from the native DP-containing sequences on the basis that pairs of spot trains deviate from the diagonal line of the 2DPEC separation, derived from the analyte-bound analytic signal and the free analytic signal, as defined in Table 3.

### Example 2

### Multiplex Assay with Isobaric Peptide Mass Tags in Combination with Difference Gel Electrophoresis

Though a variety of liquid chromatography/mass spectrometry-based approaches are gaining in prominence, proteomics still relies heavily upon the combination of 2-D gel electrophoresis and mass spectrometry. A typical 2D gel workflow in proteomics research would benefit from the described 2DPEC mass tagging approach. Seven protein samples, corresponding to seven different biological states, such as time-course or dose-response treatments with a drug, are labeled with different isobaric mass tags, the proteins are mixed together and the protein components are separated by 2D gel electrophoresis. After staining with a fluorescent dye, such as SYPRO Ruby protein gel stain (Molecular Probes/Invitrogen, Carlsbad, Calif.), an analytical imaging platform is employed to visualize the complex patterns generated by 2-D gel electrophoresis. Typically, after images are acquired, spot boundaries are detected, the amount of protein in each spot is determined, and the coordinates of each spot are established. Protein spots of interest are located, excised from gels, proteolytically digested and the peptides generated are extracted from the gel matrix. Extracted peptides are then commonly evaluated by MALDI-TOF mass spectrometer. Individual proteins are identified by comparing the actual masses of the peptide fragments generated from the proteins, with theoretical masses obtained from protein databases. The search algorithms are readily customized to account for modification by the isobaric mass tags, in an analogous manner as phosphorylation or ubiquitination is accounted for. However, there are sufficient peptides generated in a typical peptide digest to simply make the identification based upon the unmodified peptides in the digest. Additionally, a portion of this very same digested sample can be subjected to 2DPEC, as described already, and the quantities of that protein determined relative to the entire time-course or dose-response. Similar approaches can be used with standard SDS-polyacrylamide gels or with peaks obtained from chromatographic columns.

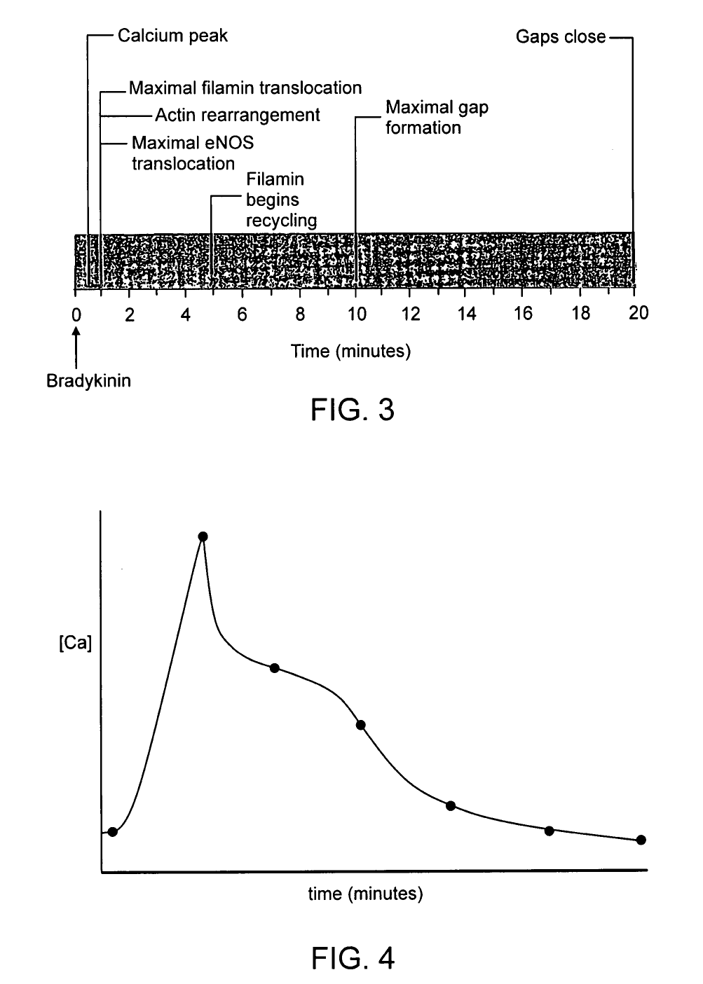

As delineated above, the 2D gel-based experiment requires prior knowledge of which protein spots warrant further investigation by 2DPEC, based upon previous experimental data, or alternatively involves blind sampling of proteins as one searches for the spots corresponding to proteins that are responsive to the experimental parameter being tested. A combination of difference gel electrophoresis (DIGE) and the isobaric mass tagging approach allows selection of proteins that are perturbed by the experimental treatment using a single 2D gel in combination with 2DPEC, as illustrated in FIGS. 3-7.

The importance of kinetic resolution for studying the proteomics of vascular permeability transitions is illustrated in FIG. 3. The multitude of physiological phenomena associated with bradykinin-induced changes in endothelial cells is summarized. Five critical time points are identified based upon different physiological parameters. FIG. 4 shows a representative kinetic inflammatory response of endothelial monolayers with respect to intracellular calcium levels. Seven discrete time-points are identified based upon this physiological response profile.

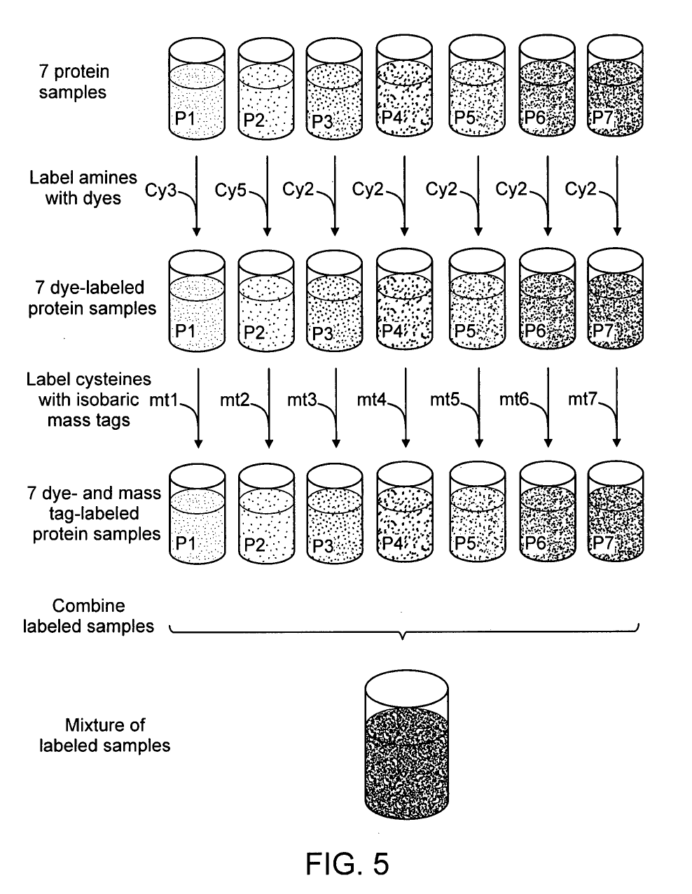

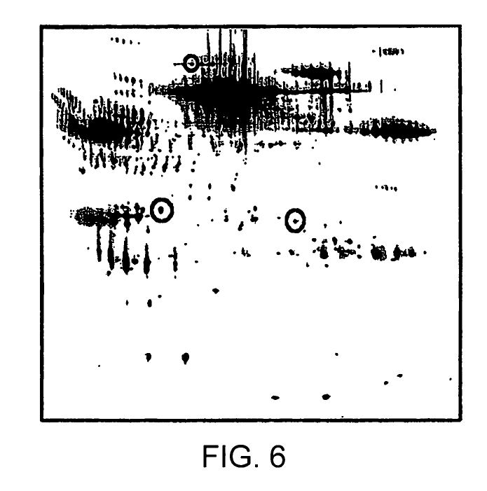

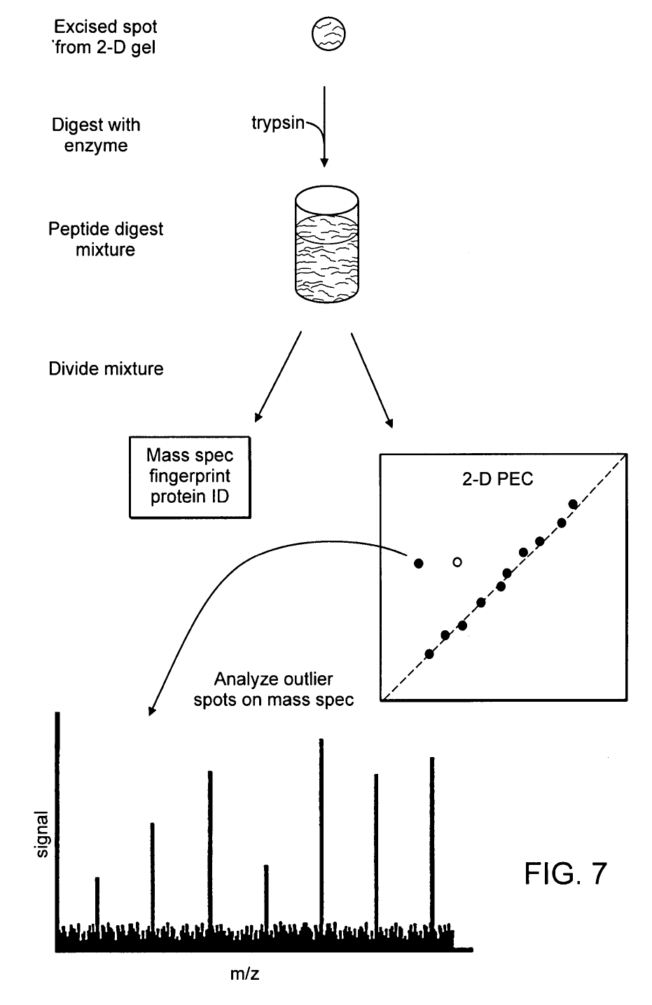

FIG. 5 shows seven isolated protein samples that correspond to the seven time-points of FIG. 4. With the multiplexing approach, N-hydroxysuccinimidyl esters of the DIGE cyanine dyes, Cy3 and Cy5, are employed to fluorescently label two of the seven different complex protein populations. In the example, the time zero and the calcium spike time-points are selected. These two samples are labeled with the Cy3 and Cy5 dyes. Since these dyes are directed at free amino groups, they can be used in conjunction with the isobaric mass tags. The mass- and charge-compensated Cy2 DIGE dye is used to label the remaining samples in the study. Alternatively, the other biological states being investigated can be labeled with a nonfluorescent amine-directed label that exhibits the same mass and charge as the fluorescent labels. All seven labeled protein mixtures will thus ultimately migrate to the same position on a 2D gel. The seven samples are next labeled with the individual isobaric mass tags prior to mixing them together. Alternatively, the isobaric mass tag labeling is performed first and the DIGE dye labeling second, or both labeling steps are performed simultaneously. Also alternatively, cysteine-directed DIGE dyes are used in combination with amine-directed isobaric mass tags. As shown in FIG. 6, the combined samples are run on the same 2-D gel. Images of the 2-D gels are acquired using the appropriate Cy3 and Cy5 excitation/emission filters, and the ratio of the differently colored fluorescent signals is used to find protein differences among the two highlighted states (circled). The Cy2 signal is not explicitly imaged. Since samples are separated under identical electrophoretic conditions, the process of registering and matching the gel images is greatly simplified. As shown in FIG. 7, the proteins of interest, identified based upon the fluorescence difference maps, are then excised, proteolytically digested and subjected to 2DPEC in order to quantitate changes in the protein over the entire set of experimental conditions, by the methods already described herein. In this example, direct analysis of the spots deviating from the diagonal line is obtained by MALDI-oTOF MS. For relatively simple samples, similar approaches can be used with standard SDS-polyacrylamide gels or with peaks obtained from chromatographic columns.

### Example 3

### Assay Using a Phos-tag™ Molecule as Mobility Modifier

Materials

One unphosphorylated peptide and three phosphopeptides were purchased from AnaSpec, Inc (San Jose, Calif.): IR (insulin receptor 1142-1153: TRDIYETDYYRK, catalog #24537), IR-2 (kinase domain of insulin receptor 2: TRDIpYETDYYRK, catalog #20292), IR-3 (kinase domain of insulin receptor 3: TRDIYETDpYYRK, catalog #20274), and IR-5 (kinase domain of insulin receptor 5: TRDIpYETDpYpYRK, catalog #20272). PIPES (piperazine-1,4-bis(2-ethanesulfonic acid), 1-butanol, pyridine, fluorescamine, and ZnCl₂ were from Sigma (St. Louis, Mo.). A biotinylated Phos-tag™ molecule (1,3-bis[bis(pyridin-2-ylmethyl)amino]propan-2-olato) was provided by the NARD Institute (Amagasaki, Japan). TLC plastic plates (silica gel 60, 20×20 cm) were from EMD Chemicals Inc (Gibbstown, N.J.). Filter papers were from Whatman (Brentford, UK). A Hunter Thin Layer Electrophoresis system used for planar electrochromatography (PEC) peptide mapping was obtained from C.B.S. Scientific Company, Inc (Del Mar, Calif.). A Linomat 5 spotting machine from CAMAG Scientific, Inc (Wilmington, N.C.) was used for sample application. A ProXPRESS 2 D Imager from PerkinElmer (Boston, Mass.) was used for peptide detection.

One-Dimensional Separation of Phosphopeptides and Peptides

2 μl of each peptide sample including IR, IR-2, IR-3, and IR-5, dissolved in distilled water with a concentration of 1 mg/ml, was spotted onto the TLC plate using the Linomat 5 sample applicator at a dosage speed of 10 nl/s. Two peptide mixtures, one containing IR and IR-3 and the other containing IR-2 and IR-5, were prepared with each component having a concentration of 0.5 mg/ml, and 5 μl of each peptide mixture was spotted on the same TLC plate as well. The spotted peptide samples were separated on the Hunter Thin Layer Electrophoresis system following the protocol recommended by the manufacturer. Briefly, the PIPES buffer (25 mM, pH 7.3) with 5% 1-butanol and 2.5% pyridine was used as the mobile phase and the separation was performed for 90 min at a constant current output of 20 mA and a constant pressure of 10 psi that was applied on top of the TLC plate. A water circulator was used to cool the TLC plate to dissipate the Joule heat generated during the separation. The TLC plate spotted with the peptide samples was first pre-wetted with the mobile phase using filter papers and then placed on the flat surface of the Hunter system with two edges of the plate (left and right) covered with the wicks (28×20 cm) that were made of filter papers and wetted with the mobile phase as well. The other sides of each wick were dipped into two separate buffer tanks each containing approximate 500 ml of the mobile phase. A voltage of about 400 volts was applied across the TLC plate for the electrically-driven separation of peptides.

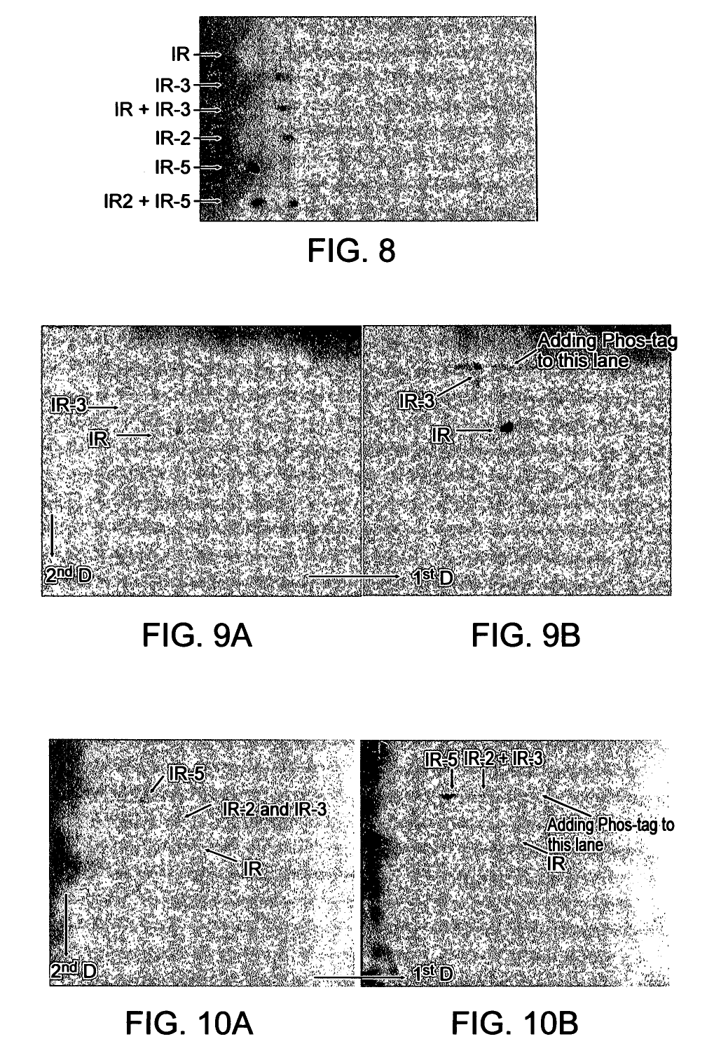

PEC separation of the chosen model peptides was first evaluated on the Hunter Thin Layer Electrophoresis system. To this end, the phosphorylated peptides including IR-2, IR-3, and IR-5, the unphosphorylated peptide IR, and two peptide mixtures were spotted on the TLC plate, respectively. The separation was performed with the optimized mobile phase of PIPES buffer at neutral pH, which is essential for the sufficient binding of Phos-tag™ molecules to phosphopeptides during the 2-D diagonal PEC peptide profiling. The major driving forces for PEC separation are the electroosmotic and electrophoretic mobilities as well as the chromatographic retention. As expected, the unphosphorylated peptide IR migrated farther on the TLC plate during the 1-D PEC separation than the rest of the phosphorylated peptides (see FIG. 8) as the direction of the electrophoretic mobility of the phosphopeptides is opposite from that of the electroosmotic mobility, due to the net negative charges of the phosphopeptides, while they all have similar chromatographic characteristics due to the same peptide sequences. The mono-phosphopeptides IR-2 and IR-3, which are phosphorylated at different tyrosine amino acid residues, were separated in the same manner, and the phosphopeptide IR-5 migrated less than IR-2 and IR-3 as IR-5 has two phosphorylated tyrosine amino acids, which introduce two more negative charges to the peptide that in turn increase the electrophoretic mobility opposite to the overall migration direction.

FIG. 8 shows a one-dimensional PEC separation of phosphopeptides and unphosphorylated peptides using the Hunter Thin Layer Electrophoresis system. Separation was performed on the TLC plate for 90 min with a constant current output of 20 mA using PIPES buffer (25 mA, pH 7.3) with 5% 1-butanol and 2.5% pyridine as the mobile phase. As shown in FIG. 8, the mixed peptides are fractionated by the 1-D PEC separations with each peptide demonstrating a similar migration pattern compared to their respective individually spotted peptides.

Two-Dimensional Planar Electrochromatography (2DPEC) Phosphopeptide Profiling

A 10 mM stock solution of the biotinylated Phos-tag™ molecules having the structure: 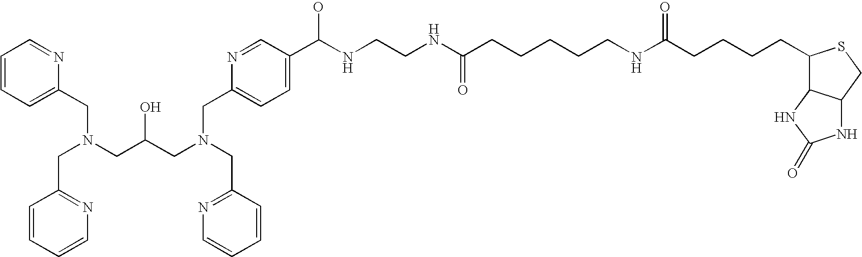
(PerkinElmer, Boston, Mass.) was made in methanol, and a mobility modifier solution was prepared by mixing the biotinylated Phos-tag™ molecules (500 μM) and ZnCl₂ (1 mM) in PIPES buffer (25 mM, pH 7.3). 5 μl of the mixed peptide sample of IR and IR-3 was spotted at the upper left-hand side of the TLC plate. The first dimension of the PEC separation of the mixed peptides was described as above on the Hunter Thin Layer Electrophoresis system using the same conditions. After the first dimension separation, the TLC plate was left to dry in the hood for an hour. 10 μl of the mobility-modifying solution was then applied manually with a pipette along the lane of the loaded sample in the direction of the first dimension separation and the plate was left to dry for half an hour. To precede the second dimension PEC separation, the above-dried plate was turned 90 degrees from its original position, and the separation was conducted in a perpendicular direction from the first dimension separation using the same mobile phase. For comparison, assays without applying the mobility modifier solution for the second dimension PEC separation were also performed for the same peptide mixture.

A mixed peptide sample comprised of all four peptides at a molar ratio of 1:1:1:1, including the phosphopeptides (IR-2, IR-3, and IR-5) and the unphosphorylated peptide (IR), was also prepared for the two-dimensional PEC peptide profiling as described above. After separation, the dried TLC plates were directly stained with 0.05% fluorescamine in cold acetone using a sprayer and the peptides were detected on the ProXPRESS 2 D Imager with a typical CCD exposure time of 10 s using a filter set of excitation of 390±70 nm and emission of 480±30 nm.

Two-Dimensional Non-Orthogonal Separation of Phosphopeptides with Phos-Tag™ Molecules

To assess the capability of the 2DPEC phosphopeptide profiling using a Phos-tag™ molecule, a mobility-modifying solution was prepared with the biotinylated Phos-tag™ molecule (6-(((3-(bis(pyridin-2-ylmethyl)amino)-2-hydroxypropyl)(pyridin-2-ylmethyl)amino)methyl)-N-(2-(6-(5-(2-oxohexahydro-1H-thieno[3,4-d]imidazol-4-yl)pentanamido)hexanamido)ethyl) nicotinamide, described above) and ZnCl₂ in PIPES buffer for phosphopeptide binding and applied directly to the dried TLC plate after the first dimension PEC separation. The migration of the phosphopeptides bound to the dinuclear Zn (II) Phos-tag™ complex was retarded in the second dimension PEC separation that resulted in the phosphopeptides migrating off the diagonal line generated by the unphosphorylated peptide in the mixed sample which consequently migrated in an identical manner in both dimensions (see panel B of FIGS. 9 and 10). The retarded phosphopeptides can be directly detected using a gel imaging device after post-separation staining with a fluorescent dye, such as fluorescamine, as shown in this Example and subsequently be quantitated using MALDI-o TOF MS. In comparison (see panel A of FIGS. 9 and 10), both the phosphopeptides and the unphosphorylated peptide in the mixed samples migrated identically in both dimensions of the PEC separation, when no Phos-tag™ molecules were applied before the peptides were subjected to the second dimension PEC separation, which demonstrated a non-orthogonal separation pattern.

FIG. 9 shows two-dimensional diagonal PEC phosphopeptide profiling of the mixed unphosphorylated peptide IR and phosphorylated peptide IR-3. In Panel A, no mobility modifier solution was applied before the second dimension PEC separation of the peptide mixture. In Panel B, 10 μl of the mobility modifier solution was applied along the lane of the spotted sample in the direction of the first dimension PEC separation before the second dimension PEC peptide separation.

FIG. 10 shows two-dimensional diagonal PEC phosphopeptide profiling of the mixed phosphorylated peptides of IR-2, IR-3, IR-5, and the unphosphorylated peptide IR. In Panel A, no mobility modifier solution was applied before the second dimension PEC separation of the peptide mixture. In Panel B, 10 μl of the mobility modifier solution was applied along the lane of the spotted sample in the direction of the first dimension PEC separation before the second dimension PEC peptide separation.

### Example 4

### Signal Transduction Profiling of Proteins Using Phos-Tag™ Molecule

T-cell antigen receptor (TCR) ligation initiates a series of intracellular signaling events that, depending on the maturational stage of the T cell and the setting in which receptor stimulation occurs, culminate in T-cell activation, anergy or apoptosis. ZAP-70 and Syk proteins play pivotal roles in the coupling of T-cell antigen receptor (TCR) stimulation to the activation of downstream signaling pathways (see, e.g., Williams et al. (1999) The EMBO Journal 18: 1832-1844).

Three samples of Jurkat T cells (available from the American Type Culture Collection, Manassas, Va.) are maintained in standard growth medium (RPMI 1640 available from Sigma-Aldrich, St. Louis, Mo.) supplemented with 10% fetal calf serum (FCS), 10 mM HEPES pH 7.4, 2 mM L-glutamine and 50 mM β-mercaptoethanol) at cell densities<5×10⁵ cells/ml are stimulated with 1 μM of ionomycin and/or 50 ng/ml of PMA (phorbol myristate acetate). Sample 1 is stimulated for 5 minutes, sample 2 for 1 hour and sample 3 is not stimulated at all. Stimulation of the cells results in phosphorylation of ZAP-70 protein, (e.g., Williams et al. (1999) The EMBO Journal 18: 1832-1844). Cells are then lysed in 25 mM Tris-HCl, 5 mM EDTA, 150 mM NaCl, pH 7.4, containing 1 mM sodium orthovanadate, 1% Brij-96 and the protease inhibitor cocktail. The ZAP-70 proteins are immunoprecipitated from the cleared extracts with ZAP-70-specific polyclonal antibodies, using techniques known to a person skilled in the art.

A stock solution of the biotinylated Phos-tag™ molecule (10 mM) is made in methanol, and a phosphopeptide mobility modifier solution is prepared by mixing the biotinylated Phos-tag™ molecule (500 μM) and ZnCl₂ (1 mM) in PIPES buffer (25 mM, pH 7.3). 5 μl of each Zap-70 sample is spotted at the upper left-hand side of the TLC plate. The first dimension of the PEC separation of the mixed peptides is performed as described supra on a Hunter Thin Layer Electrophoresis system using the conditions described supra. After the first dimension separation, the TLC plate is left to dry in the hood for an hour. 10 μl of the mobility modifier solution is then applied manually with a pipette along the lane of the loaded sample in the direction of the first dimension separation and the plate is left to dry for half an hour. To precede the second dimension PEC separation, the above dried plate is turned 90 degrees from its original position, and the separation is conducted in a perpendicular direction from the first dimension separation using the same mobile phase. For comparison, assays without applying the mobility-modifying solution for the second dimension PEC separation are also performed for the same samples.

The phosphopeptides can be directly detected using a gel imaging device after post-separation staining with a fluorescent dye, such as fluorescamine, can subsequently be quantitated using MALDI-o TOF MS.

A phosphorylation profile of ZAP-70 is then determined by plotting the fraction of phosphorylated ZAP-70 proteins as a function of time. An increase in the number of samples and, hence, timepoints will result in a more accurate phosphorylation profile.

Of course, one of skill in the art would recognize that the principles in this example can be applied to study a variety of systems involving phosphorylation of proteins, such as other signal transduction pathways. An overview of signal transduction pathways can be found, for example, in Krauss, Biochemistry of signal Transduction and Regulation, Wiley-VCH; 3rd Ed. (2003), incorporated herein by reference in its entirety.

### Example 5

### Phosphorylation Profiling of Proteins Using an Antibody

An assay is conducted and analyzed in the manner of Example 4, except that an anti-phosphotyrosine antibody (e.g., 4G10®, available from Millipore, Billerica, Mass.) is used to prepare the mobility-modifying solution.

### Example 6

### Cell Surface Profiling Using an Affinity Pair

Membrane proteins present can be investigated by biotinylating the surface of a cell. Thus, portions of the membrane proteins on the outside of the cell membrane are biotinylated.

A mouse embryonic stem (ES) cell line, D3 (American Type Culture Collection, Manassas, Va.), is maintained on 0.1% gelatin-coated tissue culture dishes in Dulbecco's modified Eagle's medium (Invitrogen, Carlsbad, Calif.) supplemented with 15% heat-inactivated fetal calf serum (FCS) (JRH Biosciences, Lenexa, Kans.), 0.1 mM β-mercaptoethanol, 100 U/ml penicillin, 100 μg/ml streptomycin, and 1,000 U/ml recombinant mouse LIF (ESGRO-Chemicon International, Temecula, Calif.). Undifferentiated cells can be monitored by staining with alkaline phosphatase and stage-specific embryonic antigen-1 (SSEA-1), which are cell surface markers for undifferentiated ES cells. D3 cells are grown to approximately 80% confluency on 150-mm tissue culture dishes and first incubated in serum-free Dulbecco's modified Eagle's medium for 1 h, rinsed twice with ice-cold phosphate-buffered saline (PBS: 10 mM NaH₂PO₄/Na₂HPO₄, pH 7.4, 138 mM NaCl, 2.7 mM KCl) supplemented with 0.1 mM CaCl₂, 1 mM MgCl₂ (PBS+), and then incubated with 1 mg/ml EZ-Link™ Sulfo-NHS-LC-biotin (Pierce, Rockford, Ill.) in PBS+for 20 min at 4° C. with gentle agitation. After ES cell surface proteins are removed from the supernatant, residual Sulfo-NHS-LC-biotin is quenched with 100 mM glycine in PBS+, and the cells are harvested using a plastic scraper.

Biotinylated D3 cells (approximately 4.8×10⁹ cells) are washed twice with PBS+, suspended in 10 mM Hepes-NaOH, pH 7.5, 0.25 M sucrose (8.5% w/v) and protease inhibitor cocktail (Roche Diagnostics, Basel, Switzerland), and then lysed by nitrogen cavitation (at 800 psi on ice for 20 min). The cell lysates are then centrifuged at 3,000×g for 10 min to remove large cell debris and nuclei. The supernatant is layered on a discontinuous sucrose density gradient, containing layers of 15%, 30%, 45%, and 60% sucrose (w/v) in 10 mM Hepes-NaOH, pH 7.5, and centrifuged at 100,000×g for 17 h. Resultant fractions are analyzed by sodium dodecyl sulfate polyacrylamide gel electrophoresis (SDS-PAGE) followed by western blotting using alkaline phosphatase-conjugated avidin (Pierce) or organelle-specific antibodies (Organelle Sampler kit, BD Biosciences, Lexington, Ky.). Fractions containing biotinylated proteins are combined, diluted 4-fold with distilled water, and centrifuged at 120,000×g for 2 h to obtain plasma membrane-rich pellets (Nunamura et al., Mol. Cell. Proteomics (2005) 4:1968-76).

Pellets are dissolved in an appropriate sample buffer. In one embodiment, the sample buffer is the same or similar to the liquid mobile phase. The dissolved sample is then applied to a PEC plate and subjected to PEC in the first dimension. Horseradish Peroxidase-conjugated streptavidin (Streptavidin-HRP, PerkinElmer, Boston, Mass.) is added to the plate as the mobility modifier. Thus, only membrane proteins, which have been biotinylated, will have their mobilities modified. PEC is then performed in the second dimension. Cell surface proteins which are biotinylated can be detected by their altered mobility in the second dimension of PEC using a fluorophore-tyramide detection (see, e.g., TSA™ Systems for Signal Amplification Technology Principle, PerkinElmer, Boston, Mass., incorporated herein by reference in its entirety) and optionally identified by mass spectrometry.

The many features of the technology are apparent from the description herein, and thus, it is intended to cover all such features and advantages of the technology which fall within its true spirit and scope. Further, since numerous modifications and variations will readily occur to those skilled in the art, it is not desired to limit the technology to the exact construction and operation illustrated and described, and accordingly, all suitable modifications and equivalents are considered to be within the scope of the technology. While the foregoing technology has been described in detail by way of illustration and examples, those skilled in the art will recognize that numerous modifications, substitutions, and alterations are possible.

A number of references have been cited herein, the entire contents of which have been incorporated herein by reference.

1. A method for isolating an analyte of interest in a sample suspected of containing the analyte of interest by two-dimensional planar electrochromatography comprising: a) subjecting the sample to planar electrochromatography in a first dimension; b) modifying the mobility of the analyte of interest; and c) subjecting the sample to non-orthogonal planar electrochromatography in a second dimension; wherein the mobility-modified analyte of interest migrates differently and distinguishably from the other analytes in the sample.

2. A method for isolating an analyte of interest in a sample suspected of containing the analyte of interest by two-dimensional planar electrochromatography comprising:
a) subjecting the sample to planar electrochromatography in a first dimension;
b) treating at least a portion of the sample after it has been subjected to electrochromatography in the first dimension with a mobility modifier capable of modifying the mobility of the analyte of interest; and
c) subjecting the sample treated with the mobility modifier to non-orthogonal planar electrochromatography in a second dimension;
wherein the mobility-modified analyte of interest migrates differently and distinguishably from the other analytes in the sample.

3. The method of claim 2, wherein the sample is selected from the group consisting of a biological source, an environmental source and an industrial source.

4. The method of claim 2, wherein the analyte of interest is selected from the group consisting of a protein, a peptide, a carbohydrate, a fatty acid, a chemical, a nucleic acid molecule and a lipid.

5. The method of claim 4, wherein the mobility modifier is selected from the group consisting of a protease, an endonuclease, an exonuclease, a kinase, a phosphatase, a lipidase, a glycosidase, a nucleic acid binding protein, a nucleic acid and a phosphomonoester-selective binding agent.

6. The method of claim 2, further comprising analyzing the sample prior to subjecting it to planar electrochromatography using a method selected from the group consisting of gel electrophoresis, high performance liquid chromatography and fast protein liquid chromatography.

7. The method of claim 2, further comprising pretreating the sample prior to subjecting it to planar electrochromatography.

8. The method of claim 7, wherein the sample is pretreated by contacting the sample with a reagent selected from the group consisting of an antibody, a phosphomonoester-selective binding agent, a nucleic acid binding protein, and a mass tag.

9. The method of claim 8, wherein the contacting creates a covalent or non-covalent bond between the reagent and the analyte of interest.

10. The method of claim 7, wherein the reagent is coupled to a matrix, wherein the sample is loaded onto the matrix prior subjecting the sample to planar chromatography in the first dimension.

11. The method of claim 2, further comprising quantitating the mobility modifier-treated analyte of interest subjected to planar electrochromatography in the second dimension.

12. The method of claim 2, wherein the mobility modifier is coupled to a detectable label.

13. The method of claim 12, wherein the detectable label is selected from the group consisting of a fluorescent label, a radioactive label, a luminescent label and a calorimetric label.

14. The method of claim 8, wherein the mobility modifier is selected from the group consisting of a light source, a heat source, a cooling source, an acidic solution or vapor, a basic solution or vapor, a solution comprising Zn⁺⁺ or Mn⁺⁺ ions, and an ion chelating solution.

15. The method of claim 2, further comprising coupling the analyte of interest to a first member of an affinity pair prior to subjecting it to planar electrochromatography in the first dimension.

16. The method of claim 15, wherein the mobility modifier is a second member of the affinity pair.

17. The method of claim 16, wherein the second member of the affinity pair is coupled to a detectable label.

18. A method for multiplex analysis of a protein of interest in a sample from multiple sources suspected of containing the protein of interest by two-dimensional planar electrochromatography comprising:
a) treating a plurality of sources suspected of containing the protein of interest with a set of mass tags to covalently couple the mass tags to the protein of interest, wherein each source is treated with a different mass tag from the set;
b) combining the plurality of sources suspected of containing the protein of interest treated with the set of mass tags to produce a sample;
c) subjecting the sample to planar electrochromatography in a first dimension;
d) treating at least a portion of the sample after it has been subjected to electrochromatography in the first dimension with a mobility modifier, wherein the mobility modifier fragments the mass tags into non-isobaric fragments;
e) subjecting the sample treated with the mobility modifier to non-orthogonal planar electrochromatography in a second dimension; and
f) comparing fragments of the mass tags to identify the source of the protein of interest.

19. The method of claim 18, wherein the mass tags in the set are isobaric.

20. The method of claim 18, wherein the mobility modifier is selected from the group consisting of a light source, a heat source, an acidic solution or vapor and a basic solution or vapor.

21. The method of claim 18, further comprising analyzing the sample prior to subjecting it to planar electrochromatography using a method selected from the group consisting of gel electrophoresis, high performance liquid chromatography and fast protein liquid chromatography.

22. The method of claim 19, wherein the isobaric mass tags are polypeptides.

23. The method of claim 21, wherein each isobaric mass tag comprises a labile bond selected from the group consisting of an aspartic acid-proline bond and an asparagine-proline bond.

24. The method of claim 23, wherein each isobaric mass tag has the labile bond at a different position from any other isobaric mass tag of the set.

25. The method of claim 23, wherein each isobaric mass tag has the labile bond at the same position as every other isobaric mass tag of the set.

26. The method of claim 19, further comprising quantitating the non-isobaric fragments of the isobaric mass tags.

27. The method of claim 26, wherein quantitating the non-isobaric fragments of the isobaric mass tags comprises using mass spectrometry.

28. A kit for isolating an analyte of interest in a sample suspected of containing the analyte of interest by two-dimensional planar electrochromatography comprising:
a) a matrix for use in two-dimensional planar electrochromatography;
b) a mobility modifier; and
c) a set of instructions for use.

29. The kit of claim 28, wherein the mobility modifier is selected from the group consisting of an antibody, a phosphomonoester-selective binding agent, a protease, a nucleic acid molecule, a nucleic acid binding protein, a peptide, a protein and a member of an affinity pair, kinase, a phosphatase, a lipidase, and a glycosidase.

30. The kit of claim 28, wherein the mobility modifier is coupled to a detectable label.

31. The kit of claim 28, wherein the matrix comprises a material selected from the group consisting of a non-porous particle bed, a polymeric monolith, and silica.

32. A kit for multiplex analysis of an analyte of interest in a sample from multiple sources suspected of containing the analyte of interest by two-dimensional planar electrochromatography comprising:
a) a matrix for use in two-dimensional planar electrochromatography;
b) a mobility modifier;
c) a set of isobaric mass tags; and
d) a set of instructions for use.

33. The kit of claim 32, wherein the mobility modifier is selected from the group consisting of a light source, a heat source, an acidic solution and a basic solution.

34. A kit for multiplex analysis of an analyte of interest in a sample by two-dimensional planar electrochromatography comprising:
a) a matrix for use in two-dimensional planar electrochromatography;
b) a mobility modifier;
c) a reagent that selectively binds to the analyte;
d) a set of instructions for use.

35. The kit of claim 34, wherein the reagent is selected from the group consisting of an antibody, a nucleic acid molecule, a phosphomonoester-selective binding agent, a nucleic acid binding protein, a peptide, a protein and a member of an affinity pair.

36. The kit of claim 34 wherein the mobility modifier is selected from the group consisting of a light source, a heat source, an acidic solution and a basic solution.

37. The kit of claim 36, further comprising a set of mass tags.

38. A kit for multiplex analysis of an analyte of interest in a sample from multiple sources suspected of containing the analyte of interest by two-dimensional planar electrochromatography comprising:
a) a matrix for use in two-dimensional planar electrochromatography, wherein a reagent that selectively binds to the analyte is located with the matrix;
b) a mobility modifier, wherein the mobility modifier disrupts the binding of the analyte to the reagent; and
c) a set of instructions for use.

39. The kit of claim 38, wherein the reagent is selected from the group consisting of an antibody, a nucleic acid molecule, a phosphomonoester-selective binding agent, a nucleic acid binding protein, a peptide, a protein and a member of an affinity pair.

40. The kit of claim 38, wherein the mobility modifier is selected from the group consisting of a light source, a heat source, an acidic solution and a basic solution.
